(19) United States
(12) Patent Application Publication
(10) Pub. No.: US 2017/0039664 A1
(43) Pub. Date: Feb. 9, 2017

(54) MICROLEARNING MARKETPLACE IN A MODULAR LEARNING SYSTEM

(71) Applicants: Monk Akarshala Design Private Limited, Mumbai (IN); Monk Akarshala Inc., Sacramento, CA (US)

(72) Inventor: Samridh Kapoor, Mumbai (IN)

(21) Appl. No.: 15/331,219

(22) Filed: Oct. 21, 2016

Related U.S. Application Data
(63) Continuation of application No. 14/344,669, filed on Mar. 13, 2014, now abandoned.

(30) Foreign Application Priority Data
Sep. 13, 2011 (IN) 2580/MUM/2011

(51) Int. Cl. G06Q 50/20; G06Q 20/12; G06Q 30/06

(52) U.S. Cl. CPC G06Q 50/20; G06Q 30/0635; G06Q 20/123

(57) ABSTRACT

An apparatus and method are disclosed for managing a learning marketplace in a modular learning system. The modular learning system maintains a plurality of listing items in a learning application marketplace. Learning applications, each associated with a price range, are stored in the modular learning system. After receiving a request to list a learning application for a specified price in the learning application marketplace, the modular learning system determines whether the specified price falls within the price range of the learning application and, if so, generates a listing item for the learning application. The listing item is added to the learning application marketplace.

### CROSS REFERENCE TO RELATED APPLICATIONS

This application claims the benefit of Indian Provisional Specification No. 2580/MUM/2011, titled “Microlearning Marketplace in a Modular Learning System” filed on 13-Sep.-2011, which is incorporated by reference in its entirety.

### FIELD OF THE ART

The present disclosure relates generally to modular learning systems, and more particularly to managing a microlearning marketplace in a modular learning system.

### DESCRIPTION OF THE RELATED ART

The current education environment includes members like students or learners, teachers, tutors, coaches, guides, professors or lecturers, content authors, and organizational members like preschools, schools, colleges, universities, educational boards and professional standards authorities, admission testing authorities, placement organizations, recruiters, HR departments of organizations, educational content and media publishers and local, regional, and national governments. All the above maintain some form of transactional and functional relationships with each other. A variety of educational marketplaces and stores are available physically as well as digitally for the sale or rental of educational products and services like textbook rentals, digital textbook rentals, textbook purchases, learning aids, educational software applications as well as digital or physical stores managing the sale of tuition and the corresponding fees for various preschools, schools, colleges, universities, e learning platforms, as well as tuition fees to coaches, trainers, guides, testing authorities, and many other kinds of educational offerings. Recently, modular learning system enable a plurality of kinds of users to establish transactional and functional relationships with each other, and such users include a plurality of learning users, in addition to a plurality of learning applications.

However, a modular learning system offering the purchase and performance of discrete microlearning experiences, may find it difficult to offer microlearning applications, application services like micro tutoring services, learning facility access and learning tool access or even microlearning event access or consolidated microlearning services to learning users through a traditional physical or even digital marketplace, due to the compatibility and service availability constraints of each and every listed microlearning purchase item.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

Figure (FIG. 1 is a modular learning environment including a modular learning system according to one embodiment.

FIG. 2 is a block diagram of a modular learning system according to one embodiment.

FIG. 3A is a block diagram of a learning application according to one embodiment.

FIG. 3B is a block diagram of a learning application according to an alternative embodiment.

FIG. 4 is a block diagram of a microlearning marketplace management module according to one embodiment.

FIG. 5 is an illustration of learning application listing interface items in a microlearning marketplace interface generated by the microlearning marketplace management module according to one embodiment.

FIG. 6 is an illustration of micro tutoring service listing interface items in a microlearning marketplace interface generated by the microlearning marketplace management module according to one embodiment.

FIG. 7 is an illustration of learning facility access listing interface items in a microlearning marketplace interface generated by the microlearning marketplace management module according to one embodiment.

FIG. 8 is an illustration of learning tools access/purchase listing interface items in a microlearning marketplace interface generated by the microlearning marketplace management module according to one embodiment.

FIG. 9 is an illustration of microlearning event listing interface items in a microlearning marketplace interface generated by the microlearning marketplace management module according to one embodiment.

FIG. 10 is an illustration of a microlearning service consolidation interface generated by the microlearning marketplace management module according to one embodiment.

FIG. 11 is a flow diagram of a method for managing a microlearning marketplace in a modular learning system environment according to one embodiment.

FIG. 12 illustrates components of an example machine able to read instructions from a machine-readable medium and execute them in a processor (or controller) according to one embodiment.

### DETAILED DESCRIPTION

The Figures (FIGS.) and the following description relate to embodiments by way of illustration only. It should be noted that from the following discussion, alternative embodiments of the systems, methods, figures, diagrams and interfaces disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the systems, methods, figures, diagrams and interfaces illustrated herein may be employed without departing from the principles described herein. In the following description, for the purposes of explanation, numerous specific details are set forth in order to provide a thorough understanding of the various embodiments. It will be evident, however to one skilled in the art that the various embodiments may be practiced without these specific details.

### Configuration Overview

A system and method of managing a microlearning marketplace in a modular learning system is provided. A microlearning marketplace management module in the modular learning system may comprise a plurality of modules and generators like a tutoring service purchase items database, a tool/tool access purchase items database, a learning facility access purchase items database, a microlearning visit access purchase items database, a microlearning workshop access purchase items database, a learning application purchase items database, a service usage purchase items database, a listing compatibility module, a price range database, a microlearning service consolidation module, a marketplace interface generator, a listing interface generator, a listing users database, a learning applications database and a listing items database. A method of managing a microlearning marketplace in a modular learning system environment may comprise a plurality of steps like receiving a listing request from a listing user, determining particulars of the listing request, determining microlearning application compatibility of the listing request, determining a price for each listing item, determining compatibility of the price with a price range, and displaying the listing items to a plurality of learning users upon request through a microlearning marketplace interface generated by an marketplace interface generator in the module.

FIG. 1 is a modular learning environment 100 including a modular learning system 144 according to one embodiment. Modular learning system 144 operates in modular learning environment 100 and communicates with a plurality of user devices 140 over a network 142. The user devices 140 are operated by a plurality of kinds of users in the learning environment. The user devices 140 may comprise any of a variety of computing devices, such as a desktop computer, a laptop, a mobile device, a tablet computer, a set-top box, a kiosk, interactive television, gaming console, and other computing platforms suitable for communicating with modular learning system 144. The modular learning system 144 provides a system for managing curricula, learning facilities, standardized tests, learning applications, tutors, and other modules of a learning experience in micro increments of time and money. The modular learning system 144 enables the various users to communicate with other users in a learning environment and provide services to learning user 102. The network 142 includes a wireless area network, a local area network, a General Packet Radio Service (GPRS) network, an Enhanced Data for Global Evolution (EDGE) network and the like. The user devices 140 are connected to the modular learning system 144 via the network 142.

Modular learning system 144 allows a learning user 102 to manage the purchase and performance of each module of a single microlearning service stack for a learning application (e.g., Breaststroke) or a group of learning applications (e.g., Breaststroke, Freestyle, Butterfly and Swimming Safety). Tutor access, such as access to a swimming instructor may be purchased in various increments, such as in hours. Learning content applications such as a breaststroke application with attached instructional media and other data may be purchased in timed access quantities or may be permanently purchased. Learning facility access such as an Olympic Sized Swimming Pool may be purchased in increments of hours or learning application performances such as ten laps. Learning tools or materials such as Swimming Goggles may be purchased as well. Each of these modules may be separately purchased and interacted with through an interface displayed on user device 140. In case of a learning performance which can be completed on the user device 140 itself, the learning application content is not only purchased and managed, but also performed, through an interface displayed on the user device 140. A learning user 102 may manage the purchase and performance of groups of microlearning performances in the form of learning visits and learning workshops, through an interface displayed on user device 140. Learning user 102 may manage an individual learning identity (or learning profile) and offer details of microlearning application performances completed by the learning user, as well as the personal learning metrics, scores, and reviews. This learning identity may be provided to recruiting users for the purpose of placement.

The modular learning system 144 manages, regulates and supervises the purchase, sale, preview, performance and review of a plurality of microlearning applications, each comprised modularly of a tutoring service, a learning application, learning facility access, and/or learning tools or infrastructure access, a learning visit, and/or a workshop as described in further detail below. The modular learning system 144 manages transactional and functional relationships between users of the modular learning system 144. These various users interact with the modular learning system 144 to modify learning applications and provide learning services as described below.

The modular learning system 144 may enable various other users including but not limited to tutors, authors, tool/material suppliers learning application template developers, translators, certifying user, learning facility administrators, learning event organizers, recruiters, and funders to modularly manage at least one of micro tutoring services associated with specific learning applications, microlearning content applications, microlearning application templates, translation of microlearning content applications, certification of microlearning content applications, access to learning facilities, access to learning workshops, organization of learning visits associated with specific learning applications, supply of tools, aids and/or materials, recruitment services, as well as granular funding services.

The modular learning system 144 enables a tutoring user 112 to provide micro tutoring services to learning user 102. Tutoring user 112 are typically individuals with credentials or other knowledge in the area of learning applications. The tutoring user 112 may associate themselves with particular pieces of content to and may indicate qualifications to teach each learning application, as is described further below. The modular learning system 144 manages the sale of micro tutoring services and associated tutoring user 112 with specific learning applications to learning user 102. Tutoring user 112 assist the learning user 102 with learning the subject matter of the learning application. The tutoring user may provide tutoring to the learning user 102 by meeting the learning user 102 in person to assist the learning user 102 in performing the learning application. As such, the modular learning system 144 facilitates the meeting and communication of tutors and learners. Tutoring user 112 may also provide learning performance data to the modular learning system 144. The learning performance data may indicate, for example, the level of the learner's mastery or proficiency through scoring or other metrics for reviewing performance at a learning performance task. The tutoring user 112 provides input to the modular learning system 144 using a plurality of learning applications through an interface displayed on the tutoring user's 112 user device 140.

The modular learning system 144 enables a learning application authoring user 104 to manage the drafting, editing, testing, publishing, sale and updates of learning content in applications through an interface displayed on user device 140. That is, the learning application authoring user 104 author's individual pieces of learning content which may be purchased and used by a learning user. For example, a learning application authoring user 104 may create instructional content for learning the backstroke. The instructional content may comprise instructions and multimedia, as well as directions for the learning user 102 to practice aspects of the backstroke in a suitable pool. The learning application authoring user 104 may use a pre-existing application template to create the learning application.

The modular learning system 144 enables a learning application template developing user 110 to create learning templates for use in creating learning applications. The learning application templates provide a framework for creating various types of learning applications. For example, learning application templates may comprise a quiz, simulation, role play, experiment, multimedia material, and other types of learning frameworks. The learning application template developing user 110 may manage the development, testing and sale of the learning application templates to learning application authoring users 104 through an interface displayed on a user device 140.

The modular learning system 144 enables a learning application translating user 106 to manage the translation and translation updates of learning content in applications and sale of such services to microlearning content application authors through an interface displayed on a user device 140. The translations are provided to the modular learning system 144 and may be stored with the corresponding learning application to enable providing instructions to learning users 102 in a variety of languages.

The modular learning system 144 enables a learning application certifying user 108 to certify various learning applications according to standards applied by the certifying user 108. Such certifying users may include boards of education at various levels, universities, professional standards groups, and other certification authorities. Certifying users 108 may or may not be formal institutions. For example, a certifying user may include a company establishing a set of learning applications to prepare a candidate for a job with the company. The certifying user 108 manages the certification of each learning content application as a part of their respective curricula or syllabi and manages the sale of such certification services to learning content application authoring users, through an interface displayed on user device 140.

The learning facility 132 facilitates the performance of specific learning applications available on the modular learning system 144. Learning facilities 132 may comprise any location suitable for performing types of learning applications. For example, learning facilities 132 may comprise an athletic club, a chemistry lab, a science lab, a university, a library, or a tutor's home. In some embodiments, the modular learning system 144 enables a facility administering user 124 to determine the compatibility of various learning applications which can be performed within learning facility 132 by picking the learning infrastructure available in the learning facility and associating the learning facility 132 with each learning application (e.g., Breaststroke) compatible with the learning infrastructure (e.g., Olympic sized Swimming Pool). In one embodiment, rather than expressly associating the learning facility with individual learning applications, the learning facility administering user 124 indicates to the modular learning system 144 the specific infrastructures and amenities available at the learning facility 132. In this embodiment, the modular learning system 144 enables a learning user 102 or learning application authoring user 104 to identify a learning facility 132 which is compatible with the learning application based on the infrastructure available at the learning facility 132. The modular learning system 144 may also identify compatible learning facilities based on metadata associated with the learning application and the infrastructure indicated by the learning facility administering user 124.

The learning facilities 132 may comprise a variety of types of learning facilities, such as an independent learning facility, institutional learning facility, workplace learning facility, and temporary learning facility. The modular learning system 144 enables an administrator 124 of an independent learning facility owned, managed or franchised by the modular learning system 144 to manage the sale of learning facility access for performances of specific microlearning applications as well as sale of learning tools and materials (e.g., sulphuric acid or swimming goggles) or access to the same in micro increments of time and money ($six/hour or $five/learning application performance) depending on multiple factors like the learning infrastructure to be accessed (e.g., Swimming Pool, Computers, Chemistry Lab), number of hours of access, and the like, through an interface displayed on a user device 140.

The modular learning system 144 enables an administrator 124 of an institutional learning facility like a preschool, school, college or university (e.g., Bangalore University) associated, partnered or linked with the modular learning system 144 to, in addition to managing the sale associated with the independent learning facility (e.g., learning facility access for performances of specific microlearning applications), manage the learning performances of a plurality of learners (students or outsiders) across a plurality of learning applications available on the system (with the learning user's explicit consent), optionally delegated to a plurality of teachers, professors, lecturers or coaches registered as tutoring users 112 on the modular learning system 144, through an interface displayed on a user device 140.

The modular learning system 144 enables an administrator 124 of a workspace learning facility associated, partnered or linked with the modular learning system 144 to, in addition to managing the sale associated with the independent learning facility (e.g., learning facility access for performances of specific microlearning applications), manage the learning performances of a plurality of learners (employees) across a plurality of learning applications available on the system (with the learning user's explicit consent), optionally delegated to a plurality of Human Resource Managers, Trainers and/or immediate superiors, registered as tutoring users 112 on the modular learning system, through an interface displayed on a user device 140.

The modular learning system 144 enables an administrator 124 of a temporary learning facility (e.g., a Cricket Ground available for net practice on Saturdays and Sundays from six in the morning to twelve at midnight) to, in addition to managing the sale associated with the independent learning facility (e.g., learning facility access for performances of specific microlearning applications), manage the hours of accessibility to the designated learning facility, through an interface displayed on a user device 140. In addition to managing the sale and performance of microlearning applications, an administrator of an independent, institutional, workspace, or temporary learning facility may manage the modular purchase of learning infrastructure (e.g., chemistry equipment, computers, cricket stumps) as well as learning tools, aids and materials (e.g., sulphuric acid, swimming goggles, cricket bat) from the modular learning system or a third party, topic wise, subject wise, location wise or otherwise based on the learning applications intended to be offered in the designated learning facility, through an interface displayed on a user device 140.

The modular learning system 144 enables a learning visit organizing user 114 to manage the organization of learning visits, and the sale of learning visits to learning users 102. The learning visit organizing user 114 may also associate a learning visit with compatible microlearning applications. Such learning visits may comprise, for example, a visit to a factory or industrial area, a museum, or a trip to a city. The learning visit organizing user 114 may associate the learning visit with learning applications and manage the learning performances during the learning visits. The management of performances of associated learning applications may be optionally provided by tutoring users 112. The learning visit organizing user 114 communicates with the modular learning system 144 through an interface displayed on a user device 140.

The modular learning system 144 enables a learning workshop organizing user 116 to manage the organization of workshops available to learning users 102. A workshop comprises a plurality of specific microlearning applications to be performed in the workshop, and a sequence of the microlearning applications to be performed at the workshop. The workshop may also specify learning tools, a designated learning facility, and a tutoring user or tutoring users to perform the workshop. As such, the workshop user organizes performance and modules of learning applications to be performed together with a group of learning users 102. The learning workshop organizing users 116 also manage the sale of such microlearning workshop access and manage the learning performances for a plurality of learners. The learning workshop organizing users communicate with the modular learning system 144 through an interface displayed on a user device 140.

The modular learning system 144 enables a learning tools supplying user 118 to provide learning tools and materials such as chemicals, biology samples, computer software, and other materials for use with learning applications to learning users 102. The learning tools supplying user 118 manages the organization and sale of the learning tools and materials (or optionally, access to the same) to learning users and administrators of learning facilities 132. The learning tools supplying user 118 may also associate learning tools with particular learning applications stored on modular learning system 144. Alternatively, the learning tools supplying user 118 may designate the tools available and the modular learning system 144 may determine which learning applications may require the tools provided by the learning tools supplying user 118. The learning tools supplying user communicates with the modular learning system 144 through an interface displayed on a user device 140.

The modular learning system 144 enables a recruiter 120 of learning users 102 to manage the recruitment of learning users 102 through the modular learning system 144. The recruiter 120 may view and filter learning users 102 by specific learning applications performed on the system, scores, metrics and reviews generated in relation to the learning applications performed by learning users 102. The recruiter may access and filter learning users 102 based on demographic data like the language used in performing the learning application. Recruiting user 120 may also operate as a certifying user 108 to certify particular learning applications that may be desirable to the recruiting user 120. The recruiting user may use the certified application as a filter prior considering learning users for a position. The recruiting user 120 manages recruiting access to the modular learning system 144 through an interface displayed on a user device 140.

The modular learning system 144 enables a funding user 122 of learning users 102 to provide funding and scholarship funds and other support to learning users 102. Such funding users 122 may comprise a parent, sibling, friend, spouse, relative, university, employer, or scholarship/grant offering institution. The funds may be provided for the funding of specific learning users or of specific learning applications, or of specific microlearning goods and services associated with the specific learning applications, in small increments, through an interface displayed on a user device 140.

Although the modular learning environment 100 is described as being composed of various, user devices (e.g., personal computer), a network (e.g., internet, intranet, world wide web), learning facilities (e.g., an Independent Learning Facility, an Institutional Learning Facility), it would be appreciated by one skilled in the art that fewer or more kinds of users (e.g., a Learning Application Fact Checking User, a Web Based Offsite Tutoring User), user devices (e.g., a mobile phone device, a portable gaming console device, a tablet device, a learning console device, gaming console device or server device attached to a television or other screen), networks (e.g., an intranet at a preschool, school, college, university, educational board, professional standards authority, coaching/tuition class; a social or professional network; an intranet at a company, HR department, training department and at a training organization) and learning facilities may comprise the modular learning environment 100, with the present disclosure still falling within the scope of various embodiments.

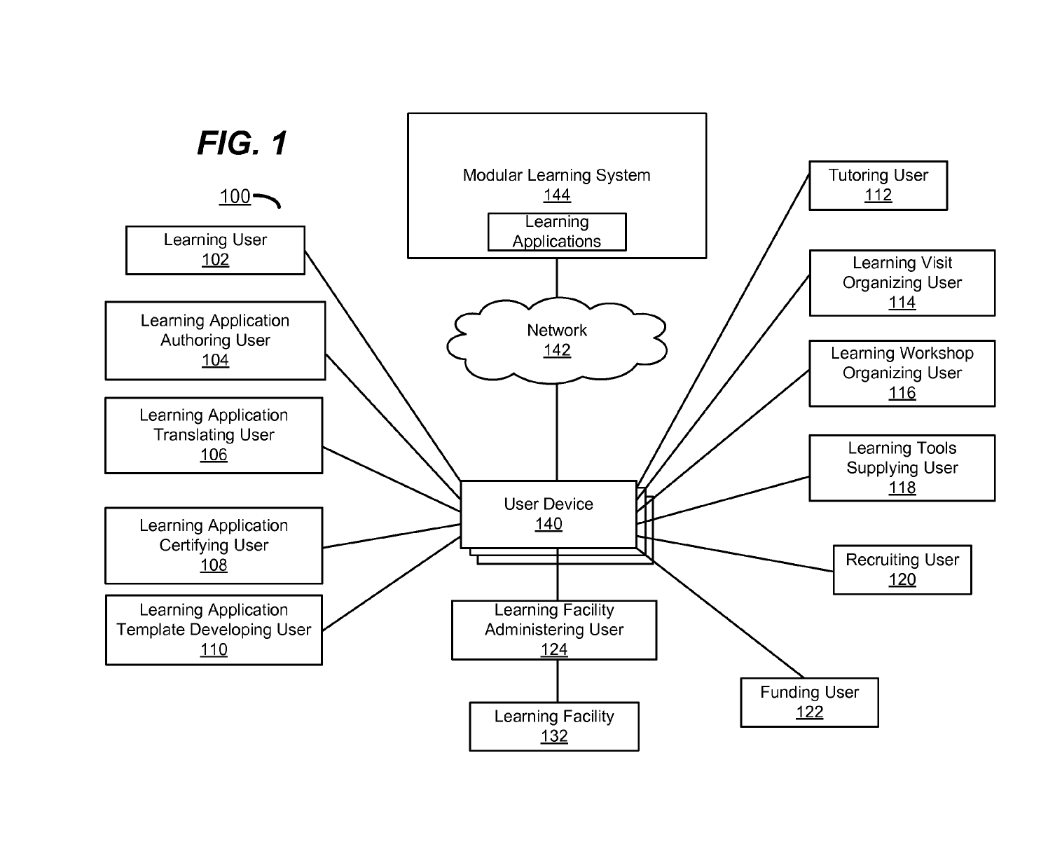

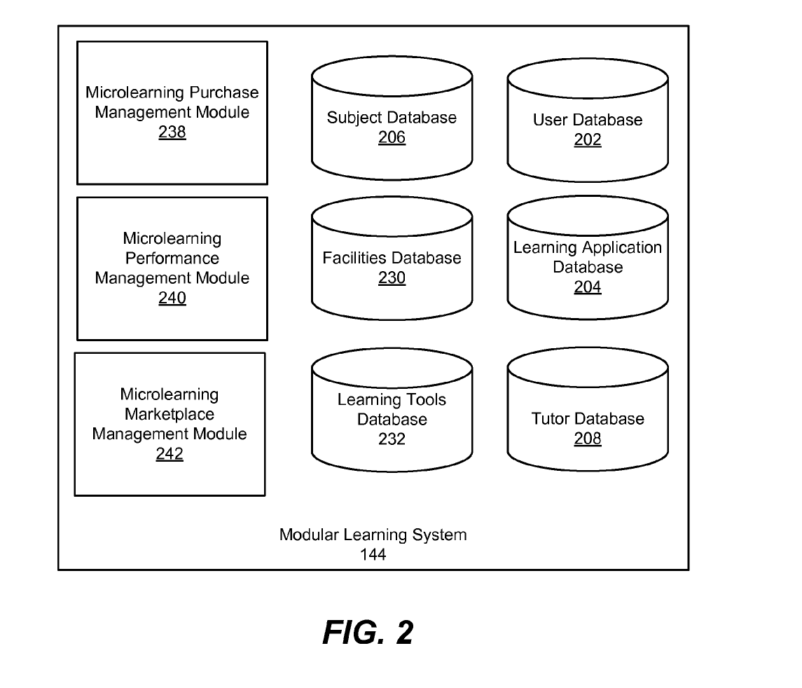

FIG. 2 is a block diagram of a modular learning system 144 according to one embodiment. The modular learning system 144 includes a variety of databases and modules for providing learning applications and learning services to users of the modular learning system 144. The modular learning system 144 maintains learning applications in a learning application database 204. The learning applications are sold to users along with microlearning services using the purchase management module 238. Performance of learning applications is enabled by performance management module 240. Additional modules of the modular learning system 144 are described below.

A user database 202 is configured for receiving, storing, updating and retrieving a plurality of data fields of each user, such as the user's name, address, and contact details. Depending on the user's role in the modular learning system 144, the user database 202 maintains additional information on the user. For example, for a learning user 102, the user database 202 maintains learning history outside the modular learning system 144, learning application performance history on the modular learning system 144, purchase history of learning applications as well as purchase history of a host of related microlearning purchase items like, for example, timed access to learning facility 132, timed access to tutor 112, and purchase of access to a learning tool from learning tools database 232. In some embodiments, the data fields are used to determine purchase compatibility using purchase management module 238 and to determine performance compatibility using performance management module 240.

The user database 202 may maintain information about each type of user based on the user's role in the system. The user information may be stored in a plurality of databases, each database associated with a user role, or the user roles may be stored in a single user database 202. For example, the additional user roles include learning application authoring users, learning facility administering users, learning visit organizing users, learning facility administering users, and other types of users of the modular learning system 144.

In one embodiment, a distinct Learning User Database is configured for receiving, storing, updating and retrieving a plurality of data fields of each learning user 102, comprising the learning user's name, address, contact details as well as learning related data fields like learning history outside the modular learning system 144, learning application performance history on the modular learning system 144, purchase history of learning applications as well as purchase history of a host of related microlearning purchase items like, for example, access to learning facility 132, access to tutor 112, and purchase of access to a learning tool. In one embodiment, a distinct Learning Application Authoring User Database is configured for receiving, storing, updating and retrieving a plurality of data fields of each learning application authoring user, say, user 104. In one embodiment, a distinct Independent Learning Facility Administering User Database is configured for receiving, storing, updating and retrieving a plurality of data fields of each independent learning facility administering user, say, user 124. In one embodiment, a distinct Learning Tools Supplying User Database is configured for receiving, storing, updating and retrieving a plurality of data fields of each learning tools supplying user, say, user 118. In one embodiment, a distinct Learning Visit Organizing User Database is configured for receiving, storing, updating and retrieving a plurality of data fields of each learning visit organizing user 114. In one embodiment, a distinct Learning Application Translating User Database is configured for receiving, storing, updating and retrieving a plurality of data fields of each learning application translating user, say, user 106. In one embodiment, a distinct Learning Application Certifying User Database is configured for receiving, storing, updating and retrieving a plurality of data fields of each learning application certifying user, say, user 108. In one embodiment, a distinct Learning Application Template Developing User Database is configured for receiving, storing, updating and retrieving a plurality of data fields of each learning application template developing user, say, user 110. In one embodiment, a distinct Learning Workshop Organizing User Database is configured for receiving, storing, updating and retrieving a plurality of data fields of each learning workshop organizing user, say, user 116. In one embodiment, a distinct Recruiting User Database is configured for receiving, storing, updating and retrieving a plurality of data fields of each recruiting user, say, recruiting user 120. In one embodiment, a distinct Funding User Database is configured for receiving, storing, updating and retrieving a plurality of data fields of each funding user, say, funding user 122.

In one embodiment, a distinct Institutional Learning Facility Administering User Database is configured for receiving, storing, updating and retrieving a plurality of data fields of each, institutional learning facility administering user, say, user 124. In one embodiment, a distinct Workspace Learning Facility Administering User Database is configured for receiving, storing, updating and retrieving a plurality of data fields of each workspace learning facility administering user, say, user 124. In one embodiment, a distinct Temporary Learning Facility Administering User Database is configured for receiving, storing, updating and retrieving a plurality of data fields of each temporary learning facility administering user, say, user 124. In one embodiment, a distinct Learning Facility Database is configured for receiving, storing, updating and retrieving a plurality of data fields of a plurality of kinds of learning facilities, say, facility 132, as received from a plurality of kinds of learning facility administering users, say, user 124. In one embodiment, a distinct Learning Visits Database is configured for receiving, storing, updating and retrieving a plurality of data fields of each learning visit from the respective learning visit organizing user, say user 114. In some embodiments, the data fields of the databases in the above embodiments are used to determine purchase compatibility using purchase management module 238 and to determine performance compatibility using performance management module 240.

The learning applications database 204 is configured for receiving, storing, retrieving and updating identifier items for the entire plurality of learning applications published on the modular learning system 144. In some embodiments, the learning applications database 204 or, optionally, a separate learning applications metadata database, is further used to receive, store, retrieve and update the entire plurality of metadata for each learning application 300 published on the modular learning system 144. The learning applications database 204 stores learning application compatibility of each application service like a micro tutoring service offered by tutoring user 112, short term learning facility access offered by independent learning facility administering user 124, and learning tool access or purchase offered by the learning tools supplying user 118. The learning applications database 204 also stores learning application compatibility of a plurality of learning applications organized in a particular sequence by microlearning event organizing user like microlearning workshop organizing user 116 or a microlearning visits organizing user 114. In such embodiments, a plurality of micro tutoring services, learning facilities, learning tool access or purchase as well as learning event access may be compatible with a single learning application, and each such compatible listing may have a unique listing item generated and stored for the same in the learning applications database 204.

In one embodiment, the learning application database 204 is configured for receiving, storing, updating and retrieving all the learning application metadata of all learning applications whose purchase is managed through the module 238. Optionally, all purchase related metadata of the learning application, like number of copies accessed per day per location, language, learning facility, user device, as well as other learning related purchase analytics metadata that may be generated during the purchase process may be received, stored, and updated by the microlearning purchase management module in the learning application database 204.

In one embodiment, the database 204 is configured for receiving, storing, updating and retrieving all the learning application metadata of all learning applications whose performance is managed through the module 240. Optionally, all performance related metadata of the learning application, like number of copies performed per day per location, language, learning facility, user device, as well as other learning related performance analytics metadata that may be generated during the performance process may be received, stored, and updated by the microlearning performance management module in the learning application database 204.

A subject database 206 is configured for receiving, storing, updating and retrieving a plurality of data fields of each subject linked or tagged to each learning application 300 in Subject Metadata 312. The subject database 206 provides a categorization system for the learning applications and enables learning application authoring users, like user 104, to categorize learning applications as belonging to one or more subjects by associating them with one or more subjects, such subjects then stored in subject metadata 312 of each authored learning application 300. The subject database 206 also allows users to search for learning applications according to particular subjects using the subjects associated with the learning applications. For example, a tutoring user 112 with a mathematics specialty may search the learning applications using the subject database 206 to identify mathematics learning applications for the tutor to associate his services with.

A tutor database 208 is configured for receiving, storing, updating and retrieving a plurality of data fields of each tutoring user, comprising the tutoring user's name, address, contact details, as well as learning related data fields like learning users to whom microlearning services have or are being provided, performance data and performance review data for the tutoring services, tutoring history outside the modular learning system 144, and remittance history. In some embodiments, the data fields are used to determine purchase compatibility using purchase management module 238 and to determine performance compatibility using performance management module 240.

A learning facility database 230 is configured for receiving, storing, updating and retrieving a plurality of data fields of a plurality of kinds of learning facilities such as learning facility 132 as received from learning facility administering users 124. In some embodiments, the data fields are used to determine purchase compatibility using purchase management module 238 and to determine performance compatibility using performance management module 240.

A learning tools database 232 is configured for receiving, storing, updating and retrieving a plurality of data fields of each learning tool or material from each learning tools supplying user 118. In some embodiments, the data fields are used to determine purchase compatibility using purchase management module 238 and to determine performance compatibility using performance management module 240.

Each of these databases, such as the tutor database 208, facilities database 230, and learning tools database 232, may also include information relating to purchase and performance compatibility. For example, a tutor in the tutor database may specify the tutor is only willing to teach students aged thirty to forty, or a learning facility may indicate it is only willing to allow entry to learning users who are a member of the facility.

A purchase management module 238 is configured for managing the purchase of learning applications and associated application services as a microlearning stack by the learning user 102.

A performance management module 240 is configured for managing the performance of learning applications and associated application services as a microlearning stack by the learning user 102.

A microlearning marketplace management module 242 is configured for managing the microlearning marketplace. In one embodiment, the microlearning marketplace management module 242 receives and processes requests from listing users to list learning applications in the microlearning marketplace. The requests may specify a price range indicating a cost that the listing user is willing to associate with each listed application. The microlearning marketplace management module 242 determines whether the price metadata associated with each application falls within the specified price range, and, if so, adds the application to the marketplace. The marketplace management module 242 also may generate interfaces displaying information about the items listed in the microlearning marketplace to users of the modular learning system 144.

In one embodiment, the tutor database, learning facilities database, tools database and other application services databases form a single consolidated application services database in modular learning system 144.

Although the modular learning system 144 is described as being composed of various modules like databases and modules, the modular learning system 144 may comprise fewer or more databases, modules, and other modules. For example, the modular learning system 144 may include a Learning Application Genre Database, a Locational Learning Facility Price Range Database, a Learning Workshop Database, a Multilingual Dictionary Database, a Concept Tags Database, a Learning Objectives/Outcomes Database, and a Micro tutoring Services Database, and a Skill and Ability Tags Database. The modular learning system 144 may also include an Age Compatibility Module, a Learner Ranking Module, a Tutor Ranking Module, a Learner Billing Module, a Tutor Remittance Module, a Profile Management Module, a User Roles Management Module, a Learning Tools Management Module, a Learning Facility Management Module, Metadata Management Module, a Notification Module, a Recruitment Module, a Funding Module, a Map Module, a Learning Application Template Programming Interface Module, an Age Compatibility Module or a Translation Interface Module, with the present disclosure still falling within the scope of various embodiments. In some embodiments, an individual or group may play a plurality of user roles on the modular learning system, (e.g., tutoring user learning new applications as a learning user through another tutoring user, a learning application authoring user translating the authored application or developing the application template), with the present disclosure still falling within the scope of various embodiments.

In various embodiments the modular learning system 144 may be any of a web application, a mobile application, or an embedded module or subsystem of a social networking environment, a learning content management system, a learning management system, a professional networking environment, an electronic commerce system, an electronic payments system, a mobile operating system, a computer based operating system, or of a tablet based operating system, with the present disclosure still falling within the scope of various embodiments.

In one embodiment, a distinct roles management module is configured for managing and authorizing different roles associated with the various users of the modular learning system 144 and in the respective user databases. For example, the roles management module may provide distinct feature tabs and functionalities to each user based on the role associated with him or her. It can be noted that, the roles management module may enable a user to have one or more roles for accessing the modular learning system 144. For example, a tutoring user can avail the functionality and interface tabs of a learning user and also of a translating user if authorized by the modular learning system 144.

In one embodiment, a distinct metadata management module is configured for managing metadata associated with a plurality of specific learning applications, like learning application 300. In one embodiment, the metadata management module is configured for receiving, storing, updating and retrieving various types of metadata associated with each learning application 300 in the learning application database 204. In another embodiment, the metadata management module is configured for receiving and storing updated metadata of a specific learning application 300 in database 204 at regular intervals of time as updated by different users in authorized user roles and retrieving the required metadata when requested by the purchase management module 238 and the performance management module 240 for determining compatibility and performance compatibility of requested microlearning service stack respectively. In yet another embodiment, the metadata management module enables various users of the modular learning platform to update metadata associated with specific learning applications in the learning application database according to their user role.

It is appreciated that, in some embodiments, various databases like 202, 204, 206, 208, 230, and 232, modules 238, 240 and 242 as well as the databases, modules, components and engines of the above embodiments may be stored in the form of machine readable instructions in the memory of the modular learning system 144 and executed by a processor of the modular learning system 144 to perform one or more embodiments disclosed herein. Alternatively, the various databases like 202, 204, 206, 208, 230, and 232, modules 238, 240 and 242 as well as the databases, modules, components and engines of the above embodiments may be implemented in the modular learning system in the form of an apparatus configured to perform one or more embodiments disclosed herein.

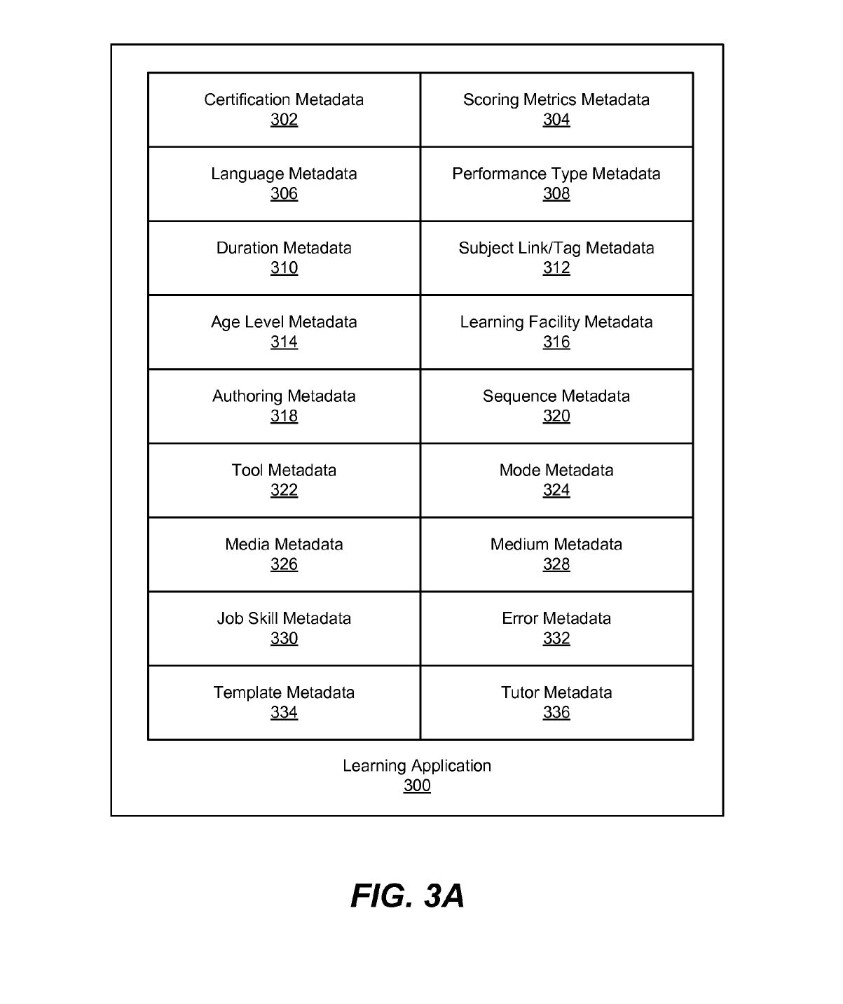

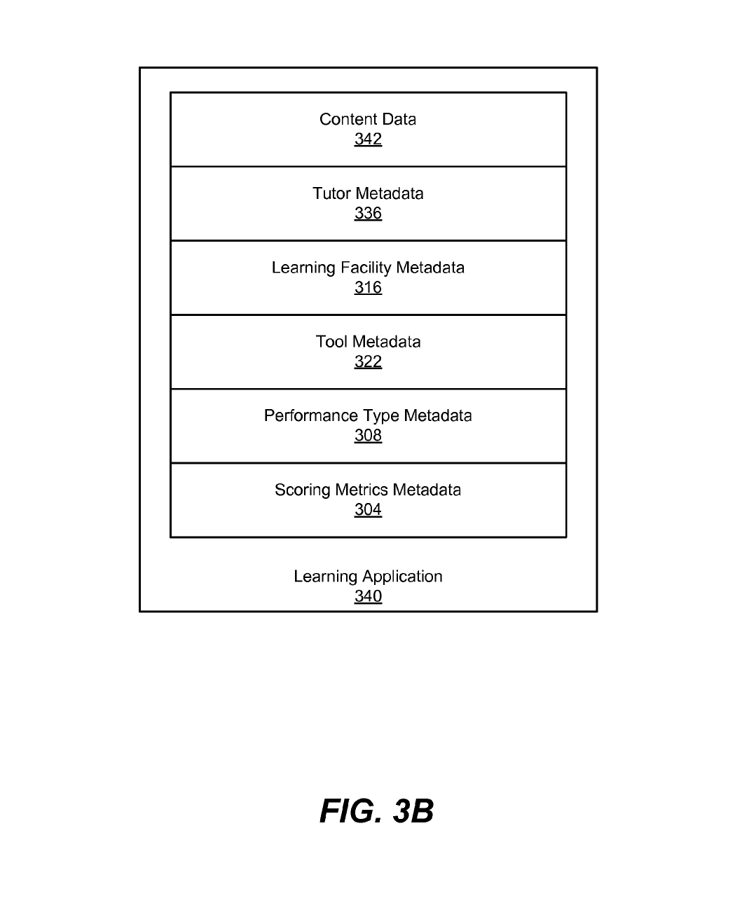

FIG. 3A is a block diagram of a learning application 300, according to one embodiment. Each learning application 300 comprises a plurality of kinds of application metadata in addition to the instructional content and associated media for a particular topic or subject. The instructional content and media of each learning application 300 may comprise a specific unit of instruction for a particular portion of knowledge or a skill, and may vary widely in scope. The learning application 300 may be very narrow in scope, such as “treading water” or may be broad in scope, such as “overview of world history”, depending on the authoring process of learning application authoring user 104. The learning application 300 could indicate a theoria (to think, a theory based application using primarily memory, reasoning, logic) performance type or a praxis performance type (to do, a practical performance type or a poeisis performance type). The learning application 300 may comprise metadata indicating associated application services for purchasing or performing the learning application 300 like tutor metadata 336, tools metadata 322 and learning facility metadata 316. In one embodiment, the learning application 300 may be requested for purchase or performance with associated application services as a microlearning service stack, wherein the application services comprise of access to tutoring user 112, access to a learning tool from learning tools database 232 and access to a learning facility from facilities database 230. For example, the media metadata 326 of a learning application 300 provided by learning application authoring user 104 may specify instructions for learning how to swim a breaststroke, but the media metadata 326 does not typically specify individual pools i.e. learning facilities to perform the learning application or tutors to coach and review the performance. Rather, the application services metadata like tutor metadata 336, tools metadata 322 and learning facility metadata 316 indicates tutors, tools, and facilities which the learning user may choose to perform the learning application's instructions.

The Certification Metadata 302 is configured for receiving, storing, retrieving, displaying and updating certification history as well as live certifications of the learning application 300, including, for example, a certification from educational board 108 and another educational board in another state, present as a certifying user in database 202 or a distinct certifying user database. In some embodiments, the certification metadata is also used to determine purchase compatibility in the microlearning purchase management module 238 through learning application database 204 and to determine performance compatibility in the microlearning performance management module 240 through learning application database 204.

The Scoring Metrics Metadata 304 is configured for receiving, storing, retrieving, displaying and updating a plurality of metrics for quantitative and qualitative scoring as defined and updated for learning application 300 by learning application authoring user 104. In some embodiments, the quantitative scoring of each metric is conducted during the performance by a dedicated module within the learning application 300 itself, while in other embodiments of a performance, especially a non-screen based praxis or poeisis performance, the quantitative and optionally, qualitative score for each metric is received through a user device 140 from the learning user 102 and/or the tutoring user 112. In some embodiments, the scoring metrics metadata is also used to determine purchase compatibility in the microlearning purchase management module 238 through learning application database 204 and to determine performance compatibility in the microlearning performance management module 240 through learning application database 204.

The Language Metadata 306 is configured for receiving, storing, retrieving, displaying and updating a plurality of translations of all user viewable application metadata for learning application 300 translated by, for example, learning application translating user 106 into Bengali, comprising of media metadata 326 like instructional text, subtitles to audio and video instructions, and all other linguistic content for the preview, performance and review of learning application 300 by learning user 102 and preview and review of the learning performance by tutoring user 112. In some embodiments, metadata 306 further comprises translations in at least one other language, of performance type metadata 308, duration metadata 310, subject links and tags metadata 312, age level metadata 314, learning facility metadata 316 authoring metadata 318, sequence metadata 320, tool metadata 322, mode metadata 324, medium metadata 328 and job skill metadata 330. In some embodiments, the language metadata is also used to determine purchase compatibility in the microlearning purchase management module 238 through learning application database 204 and to determine performance compatibility in the microlearning performance management module 240 through learning application database 204.

The Performance Type Metadata 308 is configured for receiving, storing, retrieving, displaying and updating the performance type of the learning application 300. For example, the metadata 308 could indicate a theoria (to think, a theory based application using primarily memory, reasoning, logic, like a ‘Biomechanics of Swimming’ Pop Quiz) performance type or a praxis performance type (to do, a practical performance type like an ‘eight hundred meter Freestyle Swim as per Olympic performance guidelines’ or a poeisis performance type (to make, a creation oriented performance type like a ‘five minute Synchronized Swimming Choreography’), such that the learning user is already aware of the task or performance type before purchasing and performing the learning application 300. In some embodiments, the performance type metadata is also used to determine purchase compatibility in the microlearning purchase management module 238 through learning application database 204 and to determine performance compatibility in the microlearning performance management module 240 through learning application database 204.

The Duration Metadata 310 is configured for receiving, storing, retrieving, displaying and updating the suggested duration of the learning application 300. In some embodiments, the metadata 310 indicates a fixed duration like, fifteen minutes, or thirty minutes, or one hour, while in other embodiments, the metadata indicates a variable duration with, optionally, a predetermined minimum or maximum duration depending on the duration metadata set by the learning application authoring user 104. In some embodiments, the duration metadata is also used to determine purchase compatibility in the microlearning purchase management module 238 through learning application database 204 and to determine performance compatibility in the microlearning performance management module 240 through learning application database 204.

The Subject Metadata 312 is configured for receiving, storing, retrieving, displaying and updating a plurality of subject links and tags attached to the learning application 300 by the learning content application authoring user from among the subject links and tags present in the Subject Database 206. In some embodiments, the subject links and tags are attached to specific concepts or terms within the Media Metadata 326. In some embodiments, the subject link/tag metadata is also used to determine purchase compatibility in the microlearning purchase management module 238 through learning application database 204 and to determine performance compatibility in the microlearning performance management module 240 through learning application database 204.

The Age Level Metadata 314 is configured for receiving, storing, retrieving, displaying and updating the suggested age level of the learning user 102 for performance of the learning application 300. In some embodiments, the age level is set as a minimum suggested age say, for example, over ten years old, by the learning application authoring user 104. In other embodiments, a range of suggested learner ages is set by the learning application authoring user 104. In some embodiments, the age level metadata is also used to determine purchase compatibility in the microlearning purchase management module 238 through learning application database 204 and to determine performance compatibility in the microlearning performance management module 240 through learning application database 204.

The Learning Facility Metadata 316 is configured for receiving, storing, retrieving, displaying and updating the suggested learning infrastructure required in a learning facility for performance of the learning application 300. In some embodiments, such learning facilities and infrastructure (e.g., Olympic Sized Swimming Pool) required for the performance of the learning application (e.g., eight hundred Freestyle to Olympic Guidelines) is received and updated by the learning application authoring user 104 by picking the same from a learning facility database 230 available on the modular learning system 144. In other embodiments the metadata 316 is received and updated by the administering user 124 of learning facility 132. In some embodiments, the learning facility metadata is also used to determine purchase compatibility in the microlearning purchase management module 238 through learning application database 204 and to determine performance compatibility in the microlearning performance management module 240 through learning application database 204.

The Authoring Metadata 318 is configured for receiving, storing, retrieving, displaying and updating the authoring metadata received by the learning application author 104, including for example the name, signature, contact details, intellectual property disclaimer and other information of the user or user group. In some embodiments, the metadata also includes metadata generated by the modular learning system 144 during the authoring user's editing process, including the version history, tracked changes and time stamps of edits and updates to the learning content application. In some embodiments, the metadata may al so include citations to other learning content applications or other learning content application authoring users made by the user 104.

The Sequence Metadata 320 is configured for receiving, storing, retrieving, displaying and updating the suggested sequence of performance of the learning application 300 relative to another learning application. The sequence metadata may indicate if the learning application should be performed before, after, instead of, or with another learning application by learning application authoring user 104. The user 104 may wish for any learning user, say 102 to perform an advanced microbiology learning application 300 only after performing a corresponding beginner's microbiology learning application, irrespective of the learning user's age or quality of performance. In other embodiments, wherein the learning application authoring user is not the author of the suggested beginner's application, the user 104 may input a sequence suggesting to the learning user 102 to perform the learning application before or after a learning application authored by another learning application authoring user. In some embodiments, the sequence metadata is also used to determine purchase compatibility in the microlearning purchase management module 238 through learning application database 204 and to determine performance compatibility in the microlearning performance management module 240 through learning application database 204.

The Tool Metadata 322 is configured for receiving, storing, retrieving, displaying and updating the compatible tools or learning materials to the learning application 300. In some embodiments, the tool compatibility is received from and updated by the learning application authoring user 104 by accessing the tool database 232. In other embodiments, the tool compatibility is received and updated by the learning tools supplying user 118 by accessing the learning application database 204. In still other embodiments, the tool compatibility may be updated by the modular learning system 144. In some embodiments, the tool metadata is used to determine purchase compatibility in the microlearning purchase management module 238 through learning application database 204 and to determine performance compatibility in the microlearning performance management module 240 through learning application database 204. In some embodiments, wherein the learning tool is a peripheral input device which can be connected to the user device 140 during the learning application performance (e.g., Electric Guitar attached to a user device 140 during an ‘Introduction to Hard Rock’ learning application) the Tool Metadata includes the compatibility to the user device 140. In other embodiments, wherein the learning material is not material to the user device 140, (e.g., Sulphuric Acid during a Chemistry Experiment) the Tool Metadata may not include any additional user device compatibility.

The Mode Metadata 324 is configured for receiving, storing, retrieving, displaying and updating the available modes of performance of the learning application. In some embodiments, the mode metadata is determined by the modes chosen by the learning content application authoring user from the learning application template chosen. In various embodiments, the learning application may comprise an individual learner performance mode, a learner plus learner cooperative performance mode, a learner versus learner competitive performance mode, a learner plus tutor cooperative performance mode, a learner versus tutor competitive performance mode, a limited plurality of learners (e.g., four learners) cooperative performance mode, a limited plurality of learners (e.g., four learners) competitive performance mode, a tutor plus limited plurality of learners (e.g., nine learners) cooperative performance mode (a typical classroom mode). Although the Mode Metadata is described as being composed of various available modes as chosen by the learning application authoring user, various other modes (e.g., a limited plurality of learners vs. a limited plurality of learners competitive performance mode) may comprise the Mode Metadata 324 and still fall within the scope of various embodiments. In some embodiments, the various Media Metadata for the preview, performance and review screens for each mode of the same learning application and the sequence of the same (especially wherein the learning application 300 is performed by multiple users from the same user device and, optionally, by viewing the same display device) is received, stored, retrieved, displayed and updated in the Media Metadata 326. In some embodiments, the mode metadata is also used to determine purchase compatibility in the microlearning purchase management module 238 through learning application database 204 and to determine performance compatibility in the microlearning performance management module 240 through learning application database 204.

The Media Metadata 326 is configured for receiving, storing, retrieving, displaying and updating text, image, audio, video, animation, links and other interactive elements of the learning content application as received and updated by the learning application authoring user 104 during the publishing and revision of the learning application 300. In other embodiments, the learning application Media Metadata may comprise the theoria, praxis or poeisis task or, optionally, plurality of tasks to be completed during the performance, their sequence, and, optionally, the learning outcomes and objectives of the same. In some embodiments, the media metadata is also used to determine purchase compatibility in the microlearning purchase management module 238 through learning application database 204 and to determine performance compatibility in the microlearning performance management module 240 through learning application database 204.

The Medium Metadata 328 is configured for receiving, storing, retrieving, displaying and updating the medium of access to the learning application preview, review and performance screen during the microlearning performance. For example, for a Beginner's Kathak Dancing microlearning Application, in addition to requiring a compatible learning facility and tutoring user, the learning application authoring user 104 or, optionally, modular learning system 144 may require the preview and review screen to be viewable only on a display device connected to a learning console user device or the display device of a computer device but not a mobile device screen to ensure an optimum learning experience. In another case, for a Kathak Quiz microlearning application, the learning application authoring user 104 or, optionally, modular learning system 144 may require the performance screen, preview screen and review screen to be viewable only on a mobile device screen but not on a display device connected to a learning console user device, or the display device of a computer device. In some embodiments, the medium metadata may further comprise the compatibility to a plurality of software platforms and, optionally, runtime environments as determined by the modular learning system 144. In some embodiments, the medium metadata is also used to determine purchase compatibility in the microlearning purchase management module 238 through learning application database 204 and to determine performance compatibility in the microlearning performance management module 240 through learning application database 204.

The Job Skill Metadata 330 is configured for receiving, storing, retrieving, displaying and updating the skills and abilities tagged to the learning application 300 by the learning application authoring user 104, the recruiting user 120 or, optionally, the modular learning system 144 from a skills and abilities database provided by the modular learning system 144. In some embodiments, the metadata is used by a recruiting user 120 to post the completion of the learning application (optionally, in a controlled testing environment) or group of applications as a minimum requirement for a particular job role to a plurality of potentially employable learning users. In other embodiments, the metadata is used by the recruiting user 120 to post the requirement of completion of the learning application 300 (optionally, in a controlled testing environment) or group of applications as a minimum requirement for a promotion to a higher post in a particular organization, to a plurality of potentially employable learning users. In some embodiments, the job skill metadata is also used to determine purchase compatibility in the microlearning purchase management module 238 through learning application database 204 and to determine performance compatibility in the microlearning performance management module 240 through learning application database 204.

The Error Metadata 332 is configured for receiving, storing, retrieving, displaying and updating the potential errors which can be made by the learning user 102 (e.g., 10 potential errors in an auditing microlearning application), as determined by the learning application authoring user 104. In some embodiments, wherein the learning application (e.g., a Karnataka History Quiz) is performed through an input device on a user device 140 itself, the error metadata may be synchronized to each potential input point during the learning application 300 performed through the user device 140 by the learning application authoring user 104. In some embodiments, wherein the learning application (e.g., a Karate kata) 300's error metadata is outside the recordable boundaries of the user device 140, the potential errors may be entered with reference to each instructional step of the performance by the learning application authoring user 104, such that at the time of the performance, the tutoring user (or, in some modes, the learning user 102 himself, another learning user, or the recruiting user 120) may note errors in each observable step of the performance and confirm the same on user device 140 to generate the score. In other embodiments, wherein the error observed by the observing user (say, tutoring user 112) is not part of the potential errors in the Error Metadata 332 of the application 300, the tutoring user 112 may update such errors to the Errors Metadata, or optionally, send the same to the learning application authoring user 104, to be updated after review. In some embodiments, the error metadata is also used to determine purchase compatibility in the microlearning purchase management module 238 through learning application database 204 and to determine performance compatibility in the microlearning performance management module 240 through learning application database 204.

The Template Metadata 334 is configured for receiving, storing, retrieving, displaying and updating the default script, formatting and media modules of the learning application template is used to author the learning application 300. In some embodiments, wherein a particular sequence and format of the same has been chosen by the learning content application authoring user from the options offered in the template developed by the learning application template developing user, the chosen setting may be a part of the Template Metadata 334. In various embodiments, the learning application templates may comprise a quiz, role play, simulation, project, experiment, essay, recital, research paper, race, challenge, problem, game, question, exercise or problem set. In some embodiments, the templates may be for performances conducted and supervised in front of a display device with an input device connected to the user device 140, while in other embodiments the templates may be for previews, reviews and guidelines for performances conducted without the input device, with the user device 140 merely placed next to the performance area or learning station (e.g., for Praxis Tasks in Dance Applications) as a reference point. Although the Template Metadata is described as being composed of various available templates as developed by the learning application template authoring user and chosen by the learning application authoring user, various other templates (e.g., a Swimming Race Template, a Patent Drafting Template) may comprise the Template Metadata 334 and still fall within the scope of various embodiments. In some embodiments, the template metadata is also used to determine purchase compatibility in the microlearning purchase management module 238 through learning application database 204 and to determine performance compatibility in the microlearning performance management module 240 through learning application database 204.

The Tutor Metadata 336 is configured for receiving, storing, retrieving, displaying and updating the compatibility of tutoring users to learning content application. In some embodiments, the tutoring user compatibility is received from and updated by the tutoring user 112 by updating the tutor database 208 (e.g., a Mathematics Tutoring User whose medium of instruction is Mandarin updating compatibility to a plurality of Mathematics microlearning applications available in Mandarin, in the tutor database 208). In other embodiments, the tutoring user compatibility metadata is received from and updated by the tutoring user 112 by accessing the learning application database 204. In still other embodiments, the tutoring user compatibility metadata may be updated by the modular learning system 144. In some embodiments, the Tutor Metadata is also used to determine purchase compatibility in the microlearning purchase management module 238 through learning application database 204 and to determine performance compatibility in the microlearning performance management module 240 through learning application database 204.

In various embodiments, the metadata of learning application 300 is retrieved, displayed to and updated by a plurality of kinds of users as may be applicable to the kind of metadata and the kind of user. Optionally, in addition to receiving and storing the metadata, the modular learning system 144 may update the learning application metadata as and when generated in the system through a dynamic metadata update module or through a dedicated administering user. In some embodiments, the learning application authoring user 104 may further play the role of the learning application template developing user. In some embodiments, the modular learning system 144 may play the role of the learning application authoring user 104 and, optionally, the role of the learning application template developing user 110 to author and update the media and template metadata of the learning application 300.

In some embodiments, the microlearning purchase management module 238 and microlearning performance management module 240 retrieve some or all of the above metadata associated with the learning application 300 from a learning application database 204 in a repository module of the modular learning system 144.

In some embodiments, the media metadata 326 of the learning application may comprise an electronic textbook, an electronic journal, an instructional video, or an instructional animation. In some embodiments each learning application 300, may be a distinct mobile application, browser based web application, or a desktop application. In some embodiments, each learning application 300 may be an executable file, a program, add in, macro, plug-in, or other program of instructions associated with a plurality of application programming interfaces of the modular learning system 144.

Although the learning application 300 is described as comprising various metadata and associated data fields stored and updated in learning application database 204, fewer or more metadata and associated data fields (e.g., Application Programming Interface Metadata, Organization versus Organization Social Learning Mode Metadata, University versus University Social Learning Mode Metadata, Testing Metadata, Learning Visits Metadata, Learning Workshops Metadata, Tutorials Metadata) may comprise the Learning Application 300 and associated learning application database 204, with the present disclosure still falling within the scope of various embodiments. In some embodiments, each version of the same learning application 300 with different metadata, for example language metadata, is treated as a distinct learning application in learning application database 204.

In some embodiments, an authorization to update certification metadata 302 of a learning application 300 is limited to a predetermined plurality of certifying users like user 108 and recruiting users like user 120. In some embodiments, an authorization to update scoring metrics metadata 304, performance type metadata 308, age level metadata 314, authoring metadata 318, mode metadata 324, media metadata 326, medium metadata 328, and error metadata 332 of a learning application 300 is limited to a predetermined plurality of learning application authoring users like user 104. In some embodiments, an authorization to update language metadata 306 of a learning application 300 is limited to a predetermined plurality of learning application translating users 106. In some embodiments, an authorization to update duration metadata 310 of a learning application 300 is limited to a predetermined plurality of learning application authoring users like user 104 and learning application template developing users like user 110. In some embodiments, an authorization to update subject link/tag metadata 312 of a learning application 300 is limited to a predetermined plurality of users in any user role. In various embodiments, such authorizations may be set by an administrator of system 144 based on the user role, user profile information and user preferences information of the corresponding users.

In some embodiments, an authorization to update learning facility metadata 316 of a learning application 300 with associated learning facilities is limited to a predetermined plurality of learning facility administering users like user 124. In some embodiments, an authorization to update sequence metadata 320 of a learning application 300 is limited to a predetermined plurality of learning application authoring users like user 104 and tutoring users like user 112. In some embodiments, an authorization to update tool metadata 322 of a learning application 300 with associated learning tools is limited to a predetermined plurality of tool supplying users like user 118. In some embodiments, an authorization to update job skill metadata 330 of a learning application 300 is limited to a predetermined plurality of recruiting users like user 120. In some embodiments, an authorization to update template metadata 334 of a learning application 300 is limited to a predetermined plurality of learning application authoring users like user 104 and a predetermined plurality of template developing users like user 110. In some embodiments, an authorization to update tutor metadata 336 of a learning application 300 with associated tutoring services is limited to a predetermined plurality of tutoring users like user 112. In some embodiments, an authorization to update an optional learning event metadata of a learning application 300 with associated learning workshops, visits and other learning events is limited to a predetermined plurality of learning workshop organizing users like user 116 and learning visit organizing users like user 114. In some embodiments, the associations of application services to learning applications are enabled automatically by a metadata association module in the system 144. In some embodiments, each learning application 300 is associated with a subset of learning facilities in a learning facilities database 230. In some embodiments, each learning application 300 is further associated with a subset of learning stations of each associated learning facility. In some embodiments, each learning application is associated with a subset of tutors in a tutor database 208. In some embodiments, each learning application is associated with a subset of tools in a learning tools database 232.

FIG. 3B is a block diagram of a learning application 340 according to another example embodiment. The learning application 340 is illustrated to depict metadata of the learning application related to a microlearning service stack. The learning application 340 also illustrates some other performance data used during its performance by a learner. This microlearning service stack may be requested for purchase or performance by learning user 102. In this embodiment, the microlearning service stack includes a learning application 340, a time based tutoring service by a particular tutor in database 208, time based access to a particular learning facility from database 230, and access to a particular tool from database 232. The particular services above may or may not be associated with the corresponding tutor metadata, facilities metadata, and tool metadata of learning application 340 at the time of a request. The learning application 340 includes content data 342 which designates particular content media and content attributes of the learning application 340. The learning application also includes other metadata as described above, such as tutor metadata 336, learning facility metadata 316, learning tool metadata 322, performance type metadata 308, and scoring metrics metadata 304. As such, the learning application 340 illustrates some aspects of the learning application used for purchase or performance of the learning application 340 by a learner as part of a microlearning service stack, such as content, tutors, facilities, and tools. The learning application 340 may also include any other metadata as described above with reference to FIG. 3A. Any other metadata as described above with reference to FIG. 3A may also be part of the content data 342 of the learning application 340.

The lifecycle of a learning application 300 is now described according to one embodiment. Initially, a learning application template developing user 110 creates a learning application template stored in a distinct template database in a modular learning system 144. Next, the learning application authoring user 104 publishes learning application content stored as media metadata of the learning application 300. In case a template has been chosen for the application 300, the template metadata is stored as well. The tutor metadata, learning facility metadata, learning tool metadata and other optional application services metadata indicating tutoring services, learning facilities, learning tools, and other application service types associated with the learning application 300 are dynamically updated by the corresponding tutoring users, learning facility administrators, tool suppliers and other application service providers. At this point, the learning user may modularly select application services in a microlearning stack to purchase or perform the learning application. Next, the learning user 102 selects the learning application 300 and identifies application services requested for purchase or performance as a consolidated stack. The approval of the purchase or performance request for learning application 300 and particular application services in the microlearning service stack may be determined by the specific metadata of the learning application 300 being associated with corresponding application services, and other specific metadata of the learning application being compatible with the profile information and preferences of the learning user.

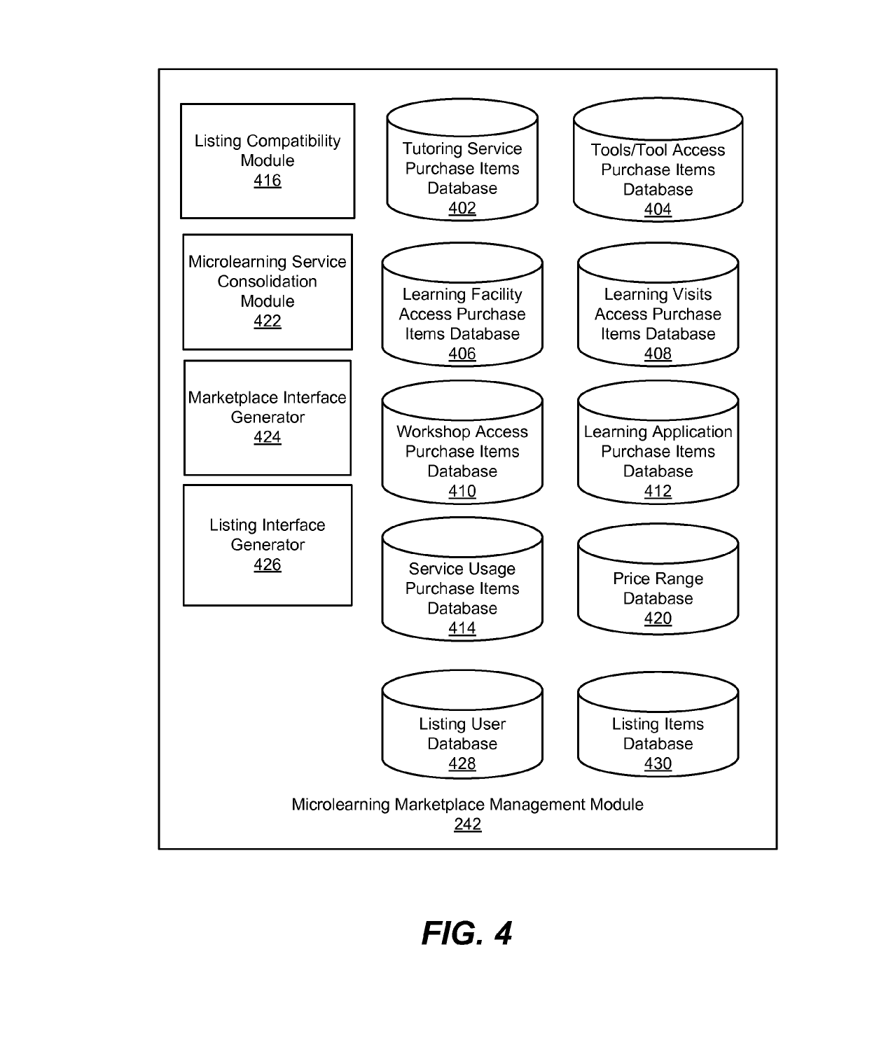

FIG. 4 is a block diagram of a microlearning marketplace management module 242. The tutoring service purchase items database 402 is configured for receiving, storing, retrieving and updating a plurality of data items for each of the subset of listing items in listing items database 430 involving the listing of a micro tutoring service for a given learning application by each tutoring user 112. The microlearning purchase management module 238 retrieves the compiled purchase items from the tutoring service purchase items database 402 at the time of processing the purchase transaction for the purchase item purchased by any learning user 102.

The tool/tool access purchase items database 404 is configured for receiving, storing, retrieving and updating a plurality of data items for each of the subset of listing items in listing items database 430 involving the listing of a purchasable/accessible tool for a given learning application by each learning tools supplying user 118. The microlearning purchase management module 238 retrieves the compiled tools purchase items from the tool/tool access purchase items database 404 at the time of processing the purchase transaction for the purchase item purchased by any learning user 102.

The learning facility access purchase items database 406 is configured for receiving, storing, retrieving and updating a plurality of data items for each of the subset of listing items in listing items database 430 involving the listing of learning facility access to a given learning facility of learning infrastructure for a given learning application by each learning facility administering user. The microlearning purchase management module 238 retrieves the compiled purchase items from the learning facility access purchase items database 406 at the time of processing the purchase transaction for the purchase item purchased by any learning user 102.

The microlearning learning visit access purchase items database 408 configured for receiving, storing, retrieving and updating a plurality of data items for each of the subset of listing items in listing items database 430 involving the listing of microlearning visit access to a given microlearning visit by each microlearning visits organizing user 114. The microlearning purchase management module 238 retrieves the compiled purchase items from the facility visit access purchase items database 408 at the time of processing the purchase transaction for the purchase item purchased by any learning user 102.

The microlearning workshop access purchase items database 410 is configured receiving, storing, retrieving and updating a plurality of data items for each of the subset of listing items in listing items database 430 involving the listing of microlearning workshop access to a given microlearning workshop by each microlearning workshop organizing user 116. The microlearning purchase management module 238 retrieves the compiled purchase items from the workshop access purchase items database 410 at the time of processing the purchase transaction for the purchase item purchased by any learning user 102 in database 202 of the modular learning system 144.

The learning application purchase items database 412 is configured for receiving, storing, retrieving and updating a plurality of data items for each of the subset of listing items in listing items database 430 involving the listing of a learning application authored by each learning application authoring user 104. The purchase item thus compiled is accessed from the database 412 by the microlearning purchase management module 238 at the time of processing the purchase transaction for the purchase item purchased by any learning user 102 in database 202 of the modular learning system 144.

The service usage purchase items database 414 is configured for receiving, storing, retrieving and updating a plurality of data items for each of the subset of listing items in listing items database 430 involving the listing of a service usage charge for microlearning service usage by the modular learning system 144. The microlearning purchase management module 238 retrieves the compiled purchase items from the service usage purchase items database 414 at the time of processing the purchase transaction for the purchase item purchased by any learning user 102.

The listing compatibility module 416 is configured for determining the compatibility of all particulars of a listing request for the learning application, application service or learning event requested to be listed in the microlearning marketplace of the modular learning system 144. In some embodiments, the listing compatibility module 416 accesses learning application database 204 and listing user database 428 and compares the learning application identifier, learning application metadata items, listing user identity items, and listing user preferences with the corresponding data fields of the listing request's listing item in listing items database 430. In one embodiment, the listing compatibility module 416 determines compatibility of the microlearning purchase items with each learning application by retrieving the purchase items of each listing user, like tutoring user 112 requesting a listing of a tutoring service in the microlearning marketplace of the modular learning system 144. Further, after an application or, optionally, a plurality of applications in case of a microlearning event, has been associated with a particular listing item, the listing compatibility module 416 may not confirm compatibility of the listing request until the learning application or plurality of learning applications preferred to be associated by the listing user with the listing item are determined as compatible with the listing user and corresponding identity items in listing user database 428. In such embodiments, the compatibility module 416 confirms the compatibility of the listing item only after determining learning application compatibility and, further, listing user compatibility for the listing item.

If a preferred price range with a minimum numerical value and maximum numerical value is stored by the modular learning system 144 for the listing item's kind of purchase item (e.g., tutoring services to be between $1 per hour and $20 per hour in Australia) or kind of listing user (e.g., all learning tools offered by learning tools supplying users to be between $1 and $1000 in Australia), the listing compatibility module 416 further retrieves the preferred price chosen or filled in by the listing user in the listing item present in listing items database 430 and determines whether the price requested to be listed in a given location and currency is within the corresponding price range for the kind of listing item stored in the price range database 420. The listing compatibility module 416 then does not request marketplace interface generator 424 to generate a corresponding listing interface item for the listing item with an incompatible price, to display the same to the plurality of learning users through a microlearning marketplace interface generated by marketplace interface generator 424 on the users' user devices 140.

In one embodiment, the price range database 420 is configured for receiving, storing, retrieving and updating a plurality of price range items with corresponding minimum numerical value data items, maximum numerical value data items and price range currency data items stored by modular learning system 144 for each kind of purchase item or, optionally, each kind of listing user. The price range database 420 is accessed by the listing compatibility module 416 to determine if the price data item within the listing item whose preferred price range item is stored in module price range database 420, is within the range of the corresponding price range item.

The microlearning service consolidation module 422 is configured for receiving, storing, retrieving and updating a plurality of microlearning service consolidation items consolidated by any learning user 102 by attaching compatible application services listing items to a given learning application listing item at the time of purchase of the same through purchase management module 238. In some embodiments, a predetermined number of such consolidation items may be received from the modular learning system 144, or optionally, a plurality of other learning users on the modular learning system 144 and simply accessed by a learning user 102 purchasing the application services along with the learning application through a single transaction with a consolidated price. In other embodiments, a learning user may individually pick a plurality of application services like access to a microscope learning tool, access to a learning facility in the vicinity, or access to a particular tutoring user for a given microbiology learning application while purchasing the application through the microlearning marketplace interface generated by the interface generator 424 and displayed to the user 102 on the user's user device 140. In such embodiments, the consolidation item thus generated or chosen is accessed by the interface generator 424 along with the individual listing items from listing items database 430. Interface generator 424 may then generate a microlearning service consolidation interface with corresponding input areas for learning applications and compatible application services to be chosen by a given learning user 102, and display the same with the corresponding listing interface items and input areas to the learning user 102 on the user 102's user device 140. The consolidation module 422 confirms the compatibility of the preferred application services chosen for the learning application by accessing the listing compatibility of the corresponding listing items from the listing compatibility module 416, and generates a microlearning service consolidation item for access and display by interface generator 426 to the learning user 102.

The marketplace interface generator 424 is configured for generating a plurality of listing interface items and, optionally, microlearning service consolidation interface items by accessing the corresponding listing items and, optionally, consolidation items from listing items database 430 and, optionally, microlearning service consolidation module 422 and displays the same through a microlearning marketplace interface to accessing learning users in database 202 of the modular learning system 144 on any of the users' user devices 140. In some embodiments, the marketplace interface generator 424 may further generate a plurality of interface items received from microlearning purchase management module 238 with corresponding input areas, and display the same to each learning user 102 during the purchase of a listing item from listing items database 430, through a microlearning purchase interface, on each learning user 102's user device 140.

The listing interface generator 426 is configured for generating a plurality of listing request interface items with corresponding input areas to be chosen or filled in by each listing user from among the plurality of listing users like tutoring users, learning application authoring users, learning facility administering users, learning tools supplying users and learning event organizing users and displays the same to each listing user through a microlearning listing request interface on the listing user's user device 140. In various embodiments, the listing interface generator 426 further accesses a plurality of items from a plurality of other modules in the microlearning marketplace management module 242, generates the corresponding interface items for the items and displays the same, optionally, with corresponding input areas, to the listing user to receive a plurality of particulars and price for a given listing item in listing items database 430, as well as to display a plurality of compatibility statuses like application compatibility and price range compatibility to the listing user at various stages during the microlearning marketplace listing request, through an listing management interface generated by the listing interface generator 426 and displayed to the each listing user on the user's user device 140.

The listing users database 428 is configured for receiving, storing, retrieving and updating a plurality of identity items for each of the subset of listing users like tutoring users, learning application authoring users, learning facility administering users, learning tools supplying users and microlearning event organizing users. The listing users database 428 is accessed by the listing compatibility module 416 to determine a given listing user's compatibility with a learning application or a set of learning applications or, optionally, a plurality of other distinct item data fields like location and language while determining the compatibility of the listing user with the particulars of the listing request. In such embodiments, the listing compatibility module 416 accesses the identity items and, optionally, preference items of each listing user in database 428 to determine the listing compatibility.

The listing items database 430 is configured for receiving, storing, retrieving and updating a unique listing item for each unique listing item offered for sale by any of a plurality of tutoring users, learning application authoring users, learning facility administering users or learning tools supplying users and microlearning event organizing users. Further, in embodiments wherein a service usage amount is charged per unit of time of usage of the modular learning system 144's services, a unique listing item is also created for each of the corresponding kinds of usage purchase items listed by system 144 and present in the usage purchase items database 414. In some embodiments, each listing item may include a plurality of data items for a plurality of data fields as chosen or filled in by the listing user on the marketplace. In some embodiments, the listing items database 430 may generate a listing item with a different plurality of data fields for each kind of listing user and, optionally, each kind of purchase item.

In various examples, the tutoring user's listing item may include data items such as rate per hour, rate per application performance, name and code of the learning application, reviews and ratings from tutored learning users for the learning application, location preferences for performance of the learning application, maximum tutor learner ratio or learning application performances of the learning application, earliest service availability to tutor the learning application, instruction medium preferences.

The learning application authoring user's listing item may include data fields such as name of learning application and a summary of a plurality of metadata of the learning application like certification metadata 302, scoring metrics metadata 304, language metadata 306, performance type metadata 308, duration metadata 310, subject link/tag metadata 312, age level metadata 314, learning facility metadata 316, authoring metadata 318, sequence metadata 320, tool metadata 322, mode metadata 324, media metadata 326, medium metadata 328, job skill metadata 330, error metadata 332, template metadata 334 and tutor metadata 336.

The learning facility administering user's listing item may include data fields such as the service availability, location, application compatibility of the unit of learning infrastructure, rate per hour or per application performance for a particular unit of learning infrastructure, the learning tools supplying user's listing item may include data fields such as application compatibility of the learning tool, purchase rate, rate per hour per learning application performance of access, and learning facility access points.

The learning event organizing user's listing item may include data fields such as names and codes of learning applications, start date, end date, location, and rate for individual learning user event access.

Although the data items and corresponding data fields for a particular microlearning listing item is described as being composed of various data items and fields, fewer or more data items and fields (e.g., translation badge item or certification badge item in a learning application listing item, a learning user capacity item in a microlearning visit or workshop listing item) may comprise a given listing item, with the present invention still falling within the scope of various embodiments. If a prepaid virtual currency or point system is used to pay for each such listing item, the prices of each purchase item as listed in the listing item may include a numerical value representing the price of the listing item in the prepaid virtual currency or point system with the present invention still falling within the scope of various embodiments. Further, in such embodiments, a prepaid currency purchase items database may be accessed by listing items database 430 to generate a unique listing item for each prepaid currency purchase item, with a plurality of numerical values in corresponding data fields indicating the price in a specified currency as well as the number of units of the currency or points available for purchase for the price. If the listing compatibility module 416 indicates that the listing item is available for purchase in more than one country or economic area, a currency preferences database may receive, store, retrieve and update a plurality of currency preferences to be chosen by a learning user 102 accessing the microlearning marketplace through a currency preference interface generated by interface generator 424 and displayed to the learning user 102 on user 102's user device 140. In such embodiments, the listing items database 430 may list a plurality of listing items for a single purchase item with the currency and corresponding price different in each listing item for the plurality of currencies in which the listing item can be purchased. In such cases, the listing items database 430 may list a plurality of listing items for a single purchase item with the language of the corresponding data items different in each listing item for the plurality of languages in which the listing item can be viewed and, optionally, purchased.

Although the microlearning marketplace management module 242 is described as being composed of various modules and databases, fewer or more modules or databases (e.g., Prepaid Currency Purchase Items Database, Currency Preferences Database) may comprise the module with the present invention still falling within the scope of various embodiments.

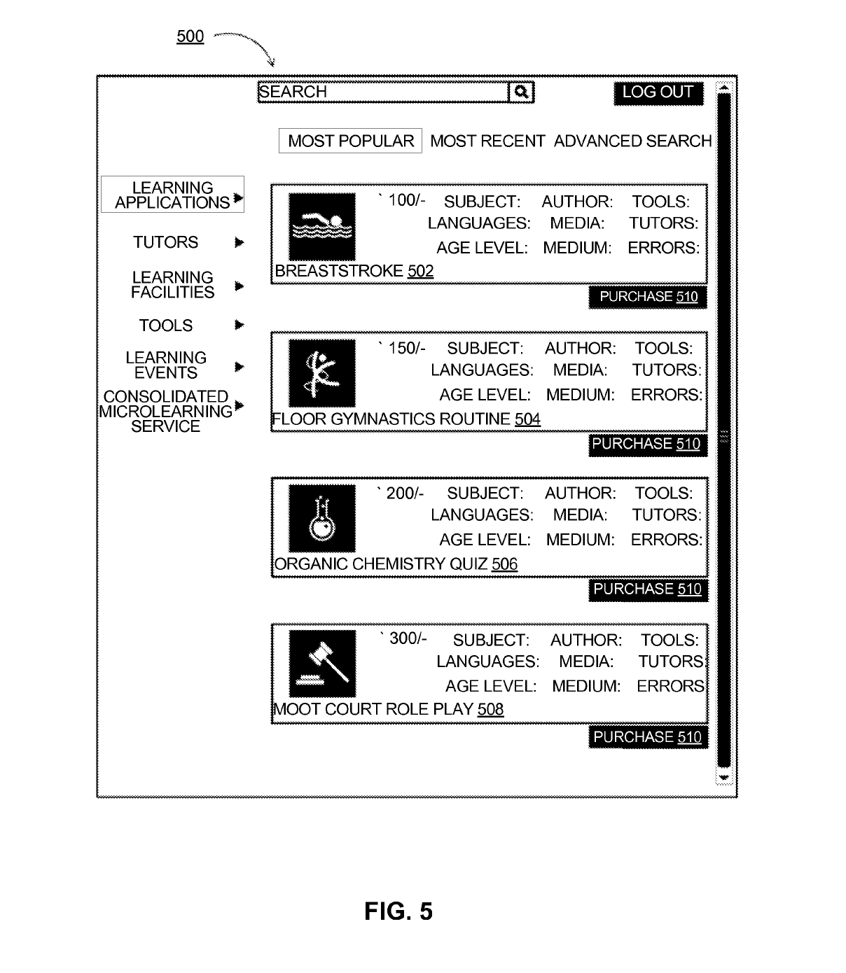

FIG. 5 is an illustration 500 of learning application listing interface items in a microlearning marketplace interface generated by a marketplace interface generator 424 and displayed to a learning user 102 on the user 102's user device 140. The listing interface cells 502, 504, 506 and 508 and corresponding items listing interface items represent corresponding listing items retrieved by marketplace interface generator 424 from listing items database 430 for a plurality of learning applications published and listed by a plurality of learning application authoring users present in the listing items database 430 of the microlearning marketplace management module 242. Each learning application is listed in association with a plurality of metadata interface items like certification metadata, scoring metrics metadata, language metadata, performance type metadata duration metadata, subject link/tag metadata, age level metadata, learning facility metadata, authoring metadata, sequence metadata, tool metadata, mode metadata, mode metadata, media metadata, medium metadata, job skill metadata, error metadata, template metadata and tutor metadata representing each learning application's metadata and, optionally, compatibility with the learning user 102 as well as a plurality of tutoring users, learning facilities and learning tools.

The price interface items in the local or preferred currency of the learning user 102 (e.g., here, Indian Rupees) represent the price preferences for the listing item as entered in by the respective learning application authoring users of the plurality of learning applications. In some embodiments, metadata interface items represent links which can be clicked on by the learning user 102 to obtain further information about the corresponding metadata item of each such learning application. For example, clicking on the certifications or translations metadata link may prompt marketplace interface generator 424 to retrieve the corresponding certification badges or optionally, translation badges from a learning application certification management module or, optionally, translation management module on the modular learning system 144 and display the corresponding interface item to the learning user 102 through the learning marketplace interface generated by marketplace interface generator 424 on the user 102's user device 140.

In other embodiments, a plurality of other metadata interface items may be links which, when clicked on by the learning user 102, may prompt marketplace interface generator 424 to retrieve the learning application's corresponding metadata item (e.g., compatible tutoring users to application 504) by accessing the same from the learning applications database 204. The plurality of links 510 represent purchase links to each learning application, which when clicked on or confirmed through any other interface input (e.g., tapping on a capacitive touch screen of a mobile phone device) may prompt the marketplace interface generator 424 to generate an learning application purchase interface and process the transaction through the microlearning purchase management module 238 of the modular learning system 144.

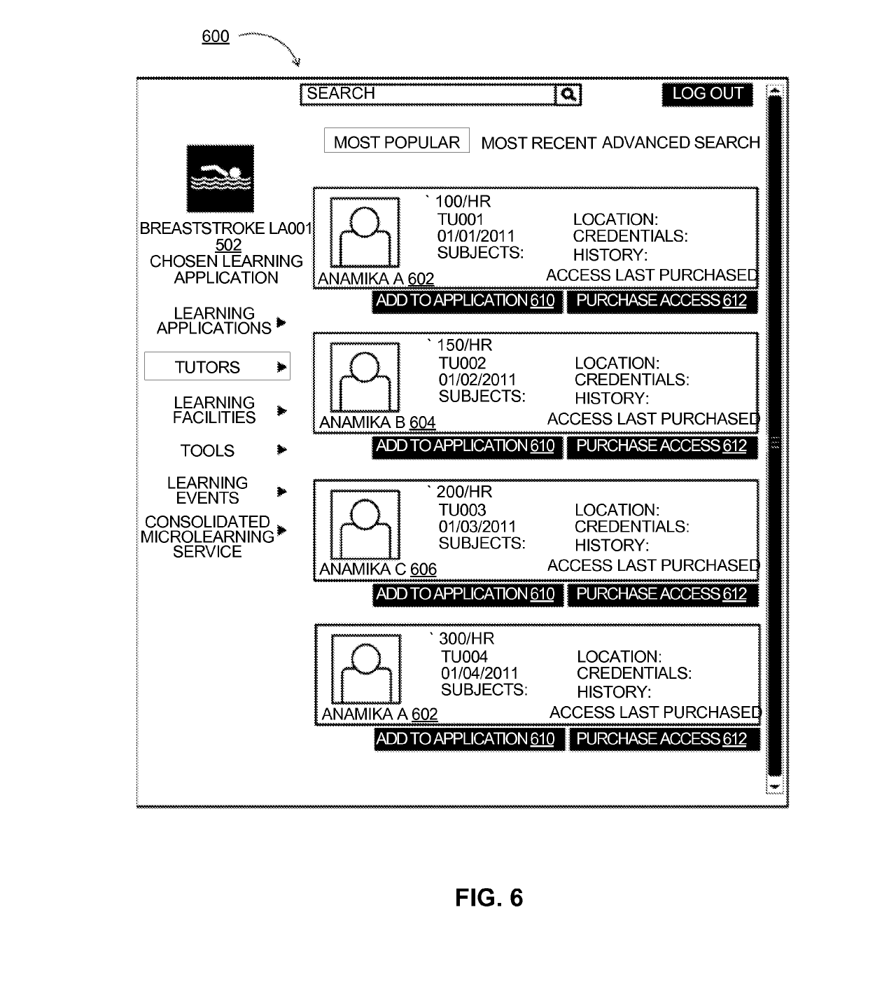

FIG. 6 is an illustration 600 of micro tutoring service listing interface items in a microlearning marketplace interface generated by a marketplace interface generator 424 and displayed to a learning user 102 on the user 102's user device 140. The listing interface cells 602, 604, 606 and 608 and corresponding listing interface items represent corresponding listing items retrieved by marketplace interface generator 424 from listing items database 430 for a plurality of listed tutoring users compatible with a chosen learning application, here the breaststroke learning application LA001 502 and present in the listing items database 430 of the microlearning marketplace management module 242. Each tutoring user is listed in associated with a plurality of identity interface items like tutor code, date of listing, subjects tutored, other compatible learning applications, location of tutor, tutor credentials and tutoring history representing each tutoring user's identity items and, optionally, compatibility with the learning user 102. In the example illustrated in FIG. 6, listing interface cells of tutoring users Anamika A 602 and Anamika B 604 include price interface items with charges for tutoring services per hour for the chosen learning application 502, while the corresponding listing interface cells of tutoring users Anamika C 606 and Anamika D 608 include price interface items for tutoring, monitoring or reviewing charges per application performance of the chosen learning application 502 by the learning user 102. The price interface items in the local or preferred currency of the learning user 102 (e.g., here, Indian Rupees) represent the price preferences for the listing item as entered in by the respective tutoring users of the plurality of tutoring services for the chosen learning application 502.

In some embodiments, the identity interface items represent links which can be clicked on by the learning user 102 to obtain further information about the corresponding identity item of each such tutoring user. For example, clicking on the tutoring history or credentials interface item of a given tutoring user may prompt marketplace interface generator 424 to retrieve the corresponding identity items of the tutoring user from the tutoring user database 204 in the modular learning system 144 and display the corresponding interface items to the learning user 102 through the learning marketplace interface generated by marketplace interface generator 424 on the user 102's user device 140. In other embodiments, a plurality of other identity interface items may be links which, when clicked on by the learning user 102 may prompt marketplace interface generator 424 to retrieve the tutor's corresponding identity item (e.g., other learning applications compatible with tutoring user 604 in the same subject, like a beginner's freestyle swimming praxis application) by accessing the same from the tutoring user database 204 of the modular learning system 144, or by accessing the tutor metadata of the chosen learning application 502 from the learning applications database 204.

The plurality of links 610 represent consolidation links to add the tutoring user's micro tutoring service for the chosen learning application 502 to a consolidated microlearning service to be purchased after consolidating a plurality of application services with the learning application by the learning user 102, which when clicked on or confirmed through any other interface input (e.g., tapping on a capacitive touchscreen of a mobile phone device) may prompt the marketplace interface generator 424 to generate a consolidated microlearning service purchase interface and process the transaction after application services associated with the chosen learning application 502 have been similarly added to the consolidated microlearning service purchase item by the learning user 102.

The plurality of links 612 represent purchase links to each tutoring user's tutoring service, which when clicked on or confirmed through any other interface input (e.g., tapping on a capacitive touch screen of a mobile phone device) may prompt the marketplace interface generator 424 to generate a tutoring service purchase interface and process the transaction through the microlearning purchase management module 238 of the modular learning system 144. If a micro tutoring service is requested to be purchased by a learning user 102 for a learning application already purchased earlier and present in the learning user 102's learning application library, clicking on the link item 612 may further prompt the marketplace interface generator 424 to display learning applications compatible with the tutoring user and already purchased and present in the learning user 102's learning application library before proceeding with requesting the microlearning purchase management module 238 to process the transaction. When the learning user 102 chooses a particular learning application from his/her library, the chosen learning application's identifier interface item may be displayed along with the plurality of listing item interface cells of potential tutoring users compatible with the learning application, and, optionally, further compatible with the learning user 102's identity items, by marketplace generator 424 through the micro tutoring service purchase interface generated by the marketplace interface generator 424, on the learning user 102's user device 140.

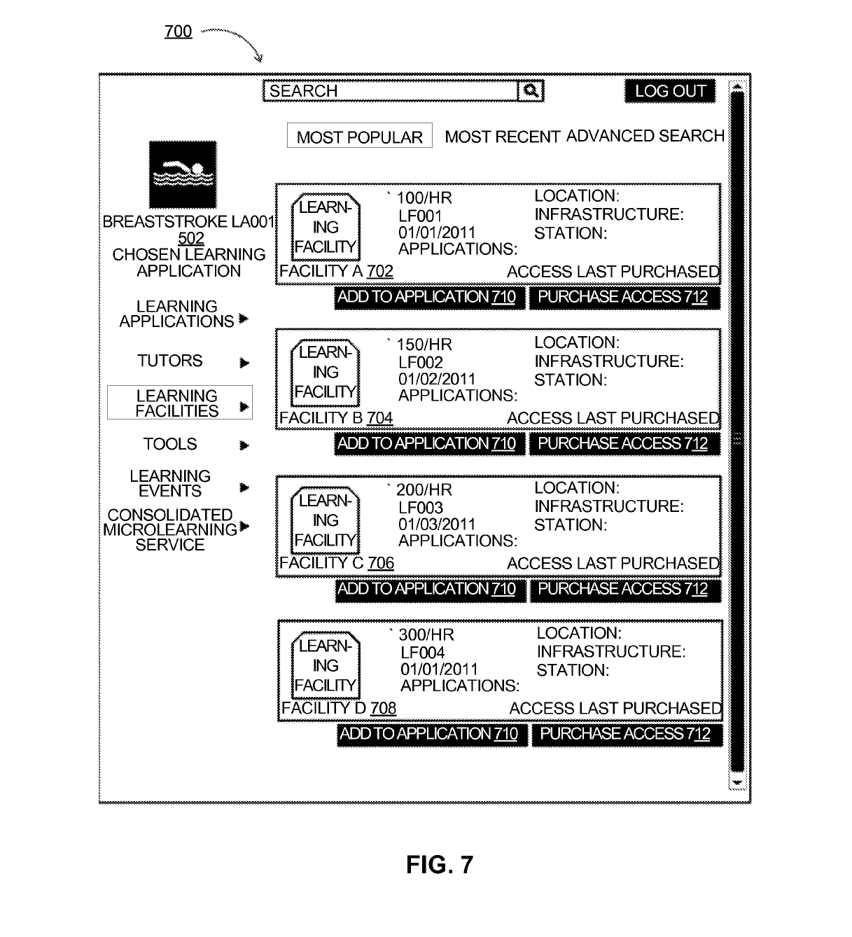

FIG. 7 is an illustration 700 of learning facility access listing interface items in a microlearning marketplace interface generated by a marketplace interface generator 424 and displayed to a learning user 102 on the user 102's user device 140. The listing interface cells 702, 704, 706 and 708 and corresponding listing interface items represent corresponding listing items retrieved by marketplace interface generator 424 from listing items database 430 for a plurality of listed learning facilities compatible with a chosen learning application, here the breaststroke learning application LA001 502 and present in the listing items database 430 of the microlearning marketplace management module 242, each with a plurality of identifier interface items like learning facility code, date of listing, learning infrastructure offered, other compatible learning applications with one or a plurality of learning infrastructure items at the learning facility with corresponding access prices, and location of learning facility representing each learning facility's identifier items and, optionally, compatibility with the learning user 102. In the example illustrated in FIG. 7, listing interface cells of learning facilities Facility A 702 and Facility B 704 include price interface items with charges for learning facility's infrastructure access per hour for the chosen learning application 502, while the corresponding listing interface cells of learning facilities Facility C 706 and Facility D 708 include price interface items for learning facility's infrastructure access charges per application performance of the chosen learning application 502 by the learning user 102. The price interface items in the local or preferred currency of the learning user 102 (e.g., here, Indian Rupees) represent the price preferences for the listing item as entered in by the respective learning facility administering users of the plurality of learning facilities.

In some embodiments, the identifier interface items represent links which can be clicked on by the learning user 102 to obtain further information about the corresponding identifier item of each such learning facility or learning infrastructure at the learning facility. For example, clicking on the location identifier link may prompt marketplace interface generator 424 to retrieve the corresponding learning facility location data item from the learning facility database 230 on the modular learning system 144 and display the corresponding interface item to the learning user 102 through the learning marketplace interface generated by marketplace interface generator 424 on the user 102's user device 140. In other embodiments, a plurality of other identifier interface items may be links which, when clicked on by the learning user 102 may prompt marketplace interface generator 424 to retrieve the learning facility's corresponding identifier item (e.g., other compatible learning applications to learning facility 704) by accessing the same from the learning applications database 204.

The plurality of links 710 represent consolidation links to add the learning facility's infrastructure access for the chosen learning application 502 to a consolidated microlearning service to be purchased after consolidating a plurality of application services with the learning application by the learning user 102, which when clicked on or confirmed through any other interface input (e.g., tapping on a capacitive touch screen of a mobile phone device) may prompt the marketplace interface generator 424 to generate a consolidated microlearning service purchase interface and process the transaction after all preferred application services for the chosen learning application 502 have been similarly added to the consolidated microlearning service purchase item by the learning user 102.

The plurality of links 712 represent purchase links for each learning facility's corresponding infrastructure access, which when clicked on or confirmed through any other interface input (e.g., tapping on a capacitive touch screen of a mobile phone device) may prompt the marketplace interface generator 424 to generate a learning facility access purchase interface and process the transaction through the microlearning purchase management module 238 of the modular learning system 144. When a learning facility's infrastructure access is requested to be purchased by a learning user 102 for a learning application already purchased earlier and present in the learning user 102's learning application library, clicking on the link item 712 may further prompt the marketplace interface generator 424 to display learning applications compatible with the learning facility's infrastructure item and already purchased and present in the learning user 102's learning application library before proceeding with requesting the microlearning purchase management module 238 to process the transaction. When the learning user 102 chooses a particular learning application from his/her library, the chosen learning application's identifier interface item may be displayed along with the plurality of listing item interface cells of potential learning facilities whose learning infrastructure items are compatible with the learning application, and, optionally, further compatible with the learning user 102's identity items, through the learning facility access purchase interface generated by the marketplace interface generator 424, on the learning user 102's user device 140.

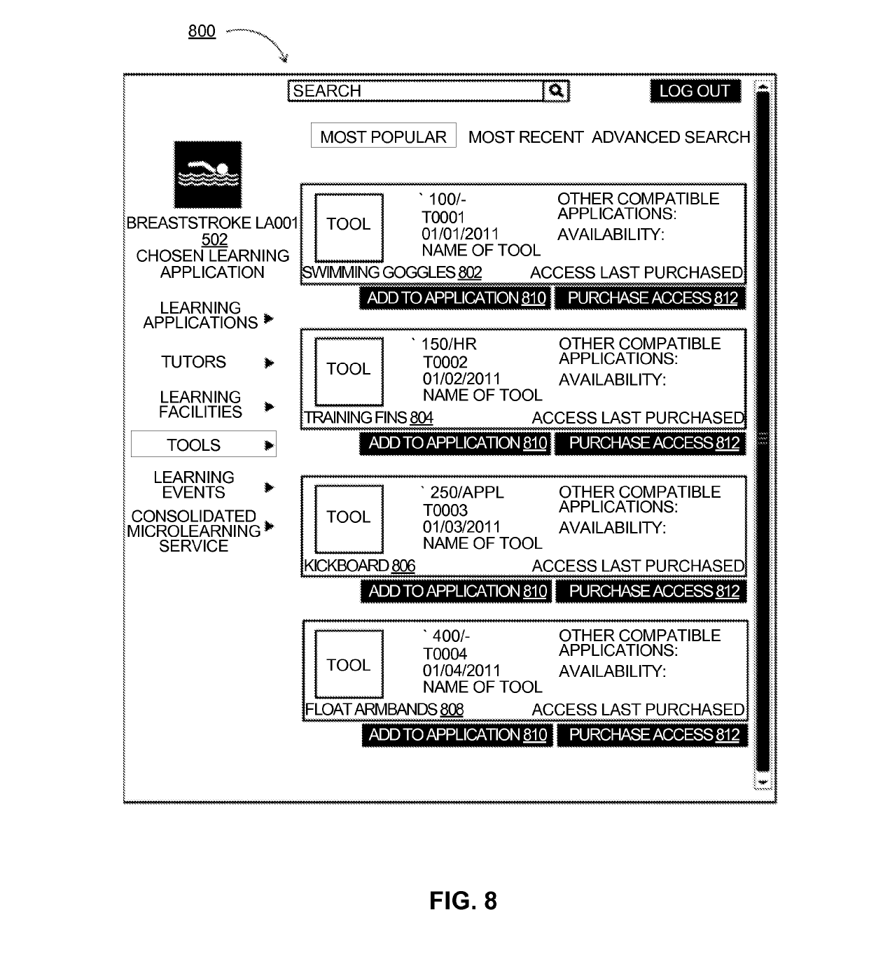

FIG. 8 is an illustration 800 of learning tools access/purchase listing interface items in a microlearning marketplace interface generated by a marketplace interface generator 424 and displayed to a learning user 102 on the user 102's user device 140. The listing interface cells 802, 804, 806 and 808 and corresponding listing interface items represent corresponding listing items retrieved by marketplace interface generator 424 from listing items database 430 for a plurality of listed learning tools compatible with a chosen learning application, here the breaststroke learning application LA001 502 and present in the listing items database 430 of the microlearning marketplace management module 242, each with a plurality of identifier interface items like learning tool code, learning tool name and, optionally, brand name, learning tool supplying user code and, optionally, name, date of listing and other compatible learning applications representing each learning tool's identifier items and, optionally, compatibility with the learning user 102. In the example illustrated in FIG. 8, listing interface cells of learning tools Swimming Goggles 802 and Float Armbands 808 include price interface items with purchase charges of the learning tools compatible with the chosen learning application 502, while the corresponding listing interface cells of learning tools Training Fins 804 and Kickboard 806 include price interface items for the learning tools' access charges per application performance and per hour respectively of the chosen learning application 502 by the learning user 102. The price interface items in the local or preferred currency of the learning user 102 (e.g., here, Indian Rupees) represent the price preferences for the listing item as entered in by the respective learning tools supplying users of the plurality of learning tools.

In some embodiments, the identifier interface items represent links which can be clicked on by the learning user 102 to obtain further information about the corresponding identifier item of each such learning tool. For example, clicking on name of the supplying user identifier link may prompt marketplace interface generator 424 to retrieve the corresponding learning tools supplying user identity items from the learning tool supplying user database 210 on the modular learning system 144 and display the corresponding interface item to the learning user 102 through the learning marketplace interface generated by marketplace interface generator 424 on the learning user 102's user device 140. In other embodiments, a plurality of other identifier interface items may be links which, when clicked on by the learning user 102 may prompt marketplace interface generator 424 to retrieve the learning tool's corresponding identifier item (e.g., other compatible learning applications to learning tool 804) by accessing the same from the learning applications database 204.

The plurality of links 810 represent consolidation links to add the learning tool purchase or learning tool access purchase for the chosen learning application 502 to a consolidated microlearning service to be purchased after consolidating a plurality of application services with the learning application by the learning user 102, which when clicked on or confirmed through any other interface input (e.g., tapping on a capacitive touchscreen of a mobile phone device) may prompt the marketplace interface generator 424 to generate a consolidated microlearning service purchase interface and process the transaction after application services associated with the chosen learning application 502 have been similarly added to the consolidated microlearning service purchase item by the learning user 102.

The plurality of links 812 represent purchase links for each learning tool purchase or learning tool access purchase, which when clicked on or confirmed through any other interface input (e.g., tapping on a capacitive touch screen of a mobile phone device) may prompt the marketplace interface generator 424 to generate a learning tool purchase interface and process the transaction through the microlearning purchase management module 238 of the modular learning system 144. If a learning tool's access or the learning tool itself is requested to be purchased by a learning user 102 for a learning application already purchased earlier and present in the learning user 102's learning application library, clicking on the link item 812 may further prompt the marketplace interface generator 424 to display learning applications compatible with the learning facility's infrastructure item and already purchased and present in the learning user 102's learning application library before proceeding with requesting the microlearning purchase management module 238 to process the transaction. When the learning user 102 chooses a particular learning application from his/her library, the chosen learning application's identifier interface item may be displayed along with the plurality of listing item interface cells of potential learning tools which are compatible with the learning application, and, optionally, further compatible with the learning user 102's identity items, through the learning tool access purchase interface generated by the marketplace interface generator 424 on the learning user 102's user device 140.

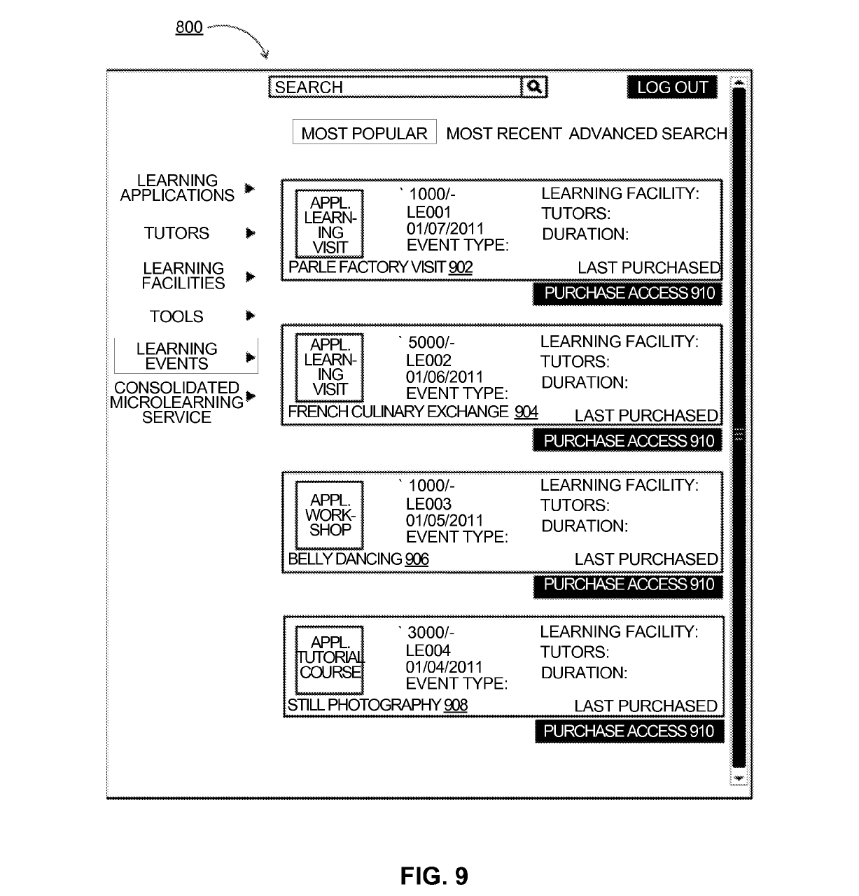

FIG. 9 is an illustration 900 of microlearning event listing interface items in a microlearning marketplace interface generated by a marketplace interface generator 424 and displayed to a learning user 102 on the user 102's user device 140. The listing interface cells 902, 904, 906 and 908 and corresponding listing interface items represent corresponding listing items retrieved by marketplace interface generator 424 from listing items database 430 for a plurality of listed microlearning events present in the listing items database 430 of the microlearning marketplace management module 242. Each microlearning event listed is associated with a plurality of identifier interface items like microlearning event code, kind of microlearning event, date of listing, subject links/tags of learning applications to be performed in the microlearning event, learning applications scheduled to be performed and tutored, monitored or reviewed, location of microlearning event, tutoring users scheduled to tutor, monitor or review the performances of each learning application or plurality of learning applications during the microlearning event, with the preferred tutor-to-learner ratio for each learning application as chosen from the mode metadata of each learning application, a learning facility code and, optionally, name with learning infrastructure data interface items for each learning application being performed during the microlearning event at each such learning facility, microlearning event performance schedule and learning user capacity for the plurality of application performances during the microlearning event, each representing the microlearning event's identifier items and, optionally, compatibility with the learning user 102. The price interface items in the local or preferred currency of the learning user 102 (e.g., here, Indian Rupees) represent the price preferences for the listing item as entered in by the respective microlearning event organizing users of the plurality of microlearning events.

In some embodiments, identifier interface items represent links that can be clicked on by the learning user 102 to obtain further information about the corresponding identifier item of each such microlearning event. For example, clicking on microlearning event schedule identifier link may prompt marketplace interface generator 424 to retrieve the corresponding microlearning event schedule item from the modular learning system 144 and display the corresponding interface item to the learning user 102 through the learning marketplace interface generated by marketplace interface generator 424 on the user 102's user device 140. In other embodiments, a plurality of other identifier interface items may be links that, when clicked on by the learning user 102, may prompt marketplace interface generator 424 to retrieve the microlearning event's corresponding identifier item (e.g., learning applications part of the microlearning event 904) by accessing the same from the learning applications database 204.

The plurality of links 910 represent purchase links to each microlearning event, which when clicked on or confirmed through any other interface input (e.g., tapping on a capacitive touch screen of a mobile phone device) may prompt the marketplace interface generator 424 to generate a microlearning event purchase interface and process the transaction through the microlearning purchase management module 238 of the modular learning system 144. In some embodiments, an plurality of links may represent learning stream addition links to add the plurality of learning application performances within a purchased or to be purchased microlearning event to the learning user 102's personalized learning stream, which when clicked on or confirmed through any interface input (e.g., tapping on a capacitive touchscreen of a mobile phone device) may prompt the module 242 to request a corresponding generator in an personalized learning stream management module in the modular learning system 144 to generate a personalized learning stream interface after the performance interface items of the plurality of learning application performances in a microlearning event purchased or confirmed to be purchased by user 102 have been added to the personalized learning stream interface item by the learning stream management module.

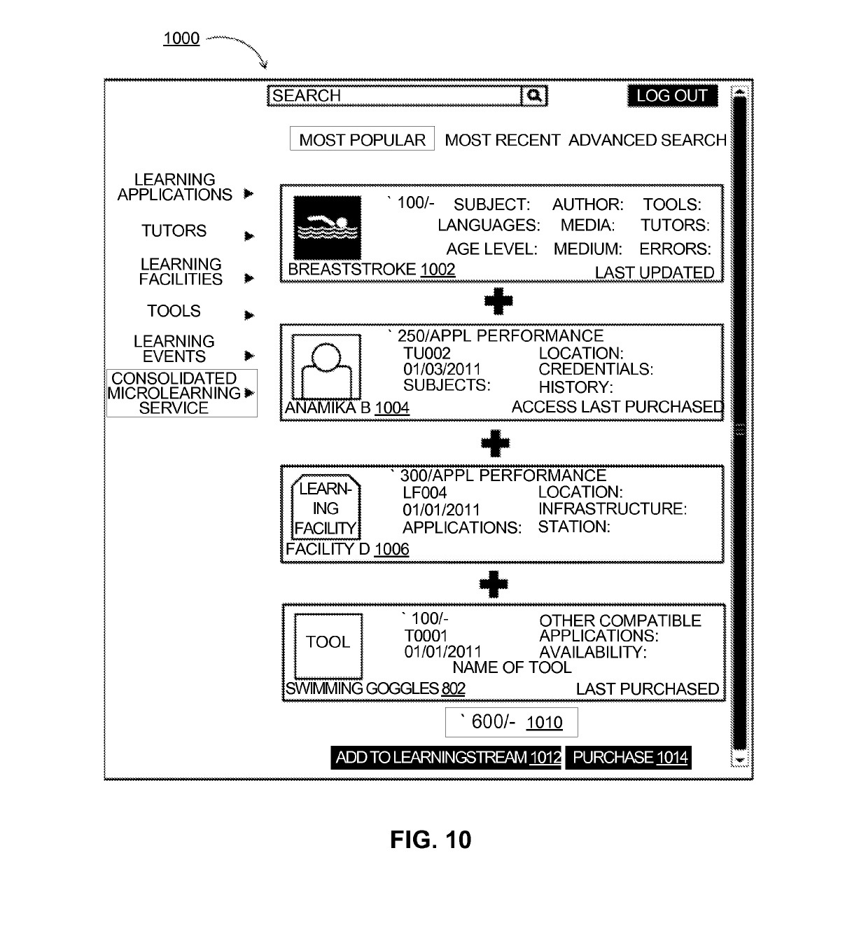

FIG. 10 is an illustration 1000 of a microlearning service consolidation interface generated by a marketplace interface generator 424 and displayed to a learning user 102 on the user 102's user device 140. The listing interface cells 1002, 1004, 1006 and 1008 corresponding to interface cells 502, 606, 708 and 802 in illustrations 500, 600, 700 and 800, and their corresponding listing interface items represent corresponding listing items retrieved by marketplace interface generator 424 from listing items database 430 for a listed learning application LA001 and a plurality of listed application services like tutoring user's micro tutoring services, learning facility access and learning tool purchase compatible for the chosen learning application, here the breaststroke learning application LA001 502 and present in a the listing items database 430 of the microlearning marketplace management module 242. Each consolidated service listed is associated with a plurality of corresponding metadata, identity or identifier interface items and, optionally, consolidated microlearning service compatibility with the learning user 102. The consolidated microlearning service price may be generated by the microlearning service consolidation module 422 and accessed by marketplace interface generator 424 to generate the corresponding consolidated microlearning service price interface item 1010 and display the same to the learning user 102 through a consolidated microlearning service purchase interface as part of the microlearning marketplace interface generated by marketplace interface generator 424, on user 102's user device 140.

The link 1014 represents a purchase link to the consolidated microlearning service, which when clicked on or confirmed through any other interface input (e.g., tapping on a capacitive touch screen of a mobile phone device) may prompt the marketplace interface generator 424 to generate a consolidated microlearning service purchase interface and process the transaction through the microlearning purchase management module 238 of the modular learning system 144. In some embodiments, a link 1012 may represent a learning stream addition link to add the learning application performance of the chosen learning application with the chosen application services to the learning user 102's personalized learning stream, optionally with prior confirmation of service availability through the personalized learning stream management module or prior confirmation of immediate service availability through the microlearning performance management module 240, which when clicked on or confirmed through any other interface input (e.g., tapping on a capacitive touchscreen of a mobile phone device) may prompt the marketplace management module 242 to request a corresponding generator in a personalized learning stream management module in the modular learning system 144 to generate a personalized learning stream interface after the performance interface item of the consolidated microlearning service's learning application performance purchased or confirmed to be purchased by user 102 has been added to the personalized learning stream interface item by the learning stream management module.

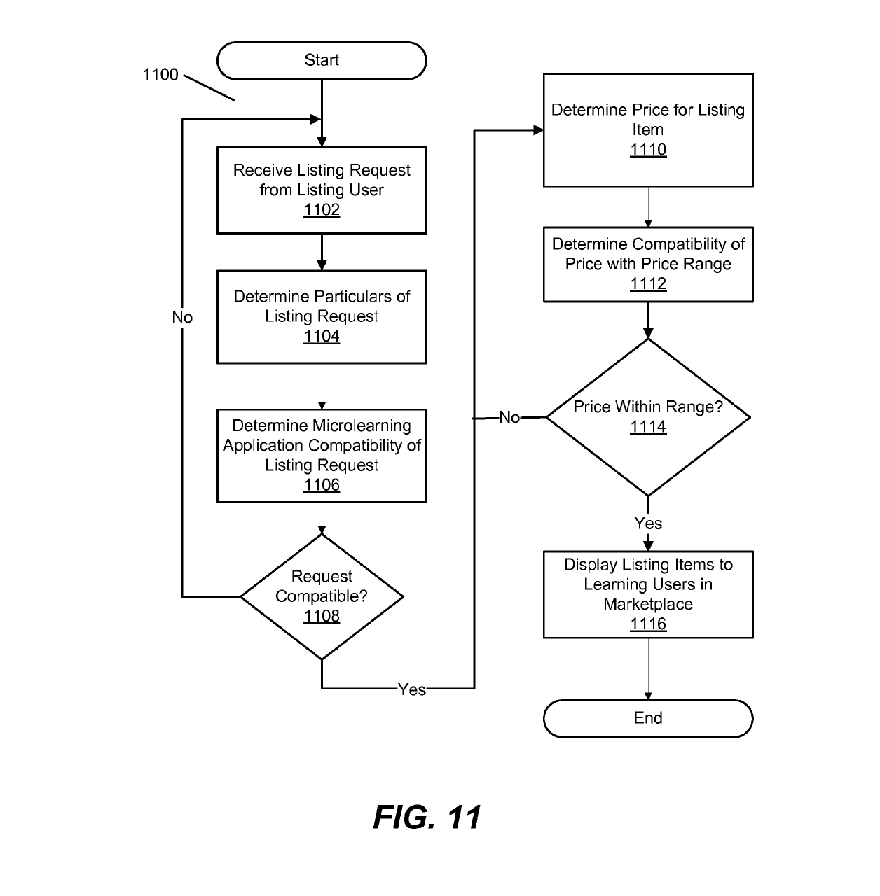

FIG. 11 is a flow diagram 1100 of a method for managing a learning marketplace in a modular learning system environment. At step 1102, the microlearning marketplace management module 242 receives a listing request from an listing user like a tutoring user, learning application authoring user, learning facility administering user, learning tools supplying user or microlearning event organizing user through an listing interface generated by listing interface generator 426 on the listing user's user device 140. At step 1104, listing interface generator 426 retrieves a listing item from listing items database 430 to generate and display a listing request interface based on the user role of the listing user (e.g., a tutoring service listing request interface for tutoring user 112) with interface items and corresponding input areas to be chosen or filled in by the listing user for a plurality of particulars of the listing request. Once the particulars are chosen or filled in by the listing user, the listing items database 430 receives the same and stores the corresponding data items of the particulars in corresponding data fields of the listing items.

At step 1106, the listing items module 428 requests the listing compatibility module 416 to determine the application compatibility of the listing item to the listing user based on the user role of the listing user and the kind of item i.e. a learning tool, a micro tutoring service, learning facility access and so on. At step 1108, the listing compatibility module 416 accesses the learning application database 204 and the listing users database 428 to determine the compatibility of the application (in case of an application service) or a plurality of applications (in case of a microlearning event) associated with the listing item by comparing the metadata of the learning application or a plurality of learning applications with the identity items and, optionally, preferences of the listing user based on the user role of the listing user. When the listing user's identity items, identifier items or metadata items or preferences are incompatible with the learning application's metadata, the listing request may be denied.

At step 1110, if the listing compatibility module 416 determines that the listing user's identity items, identifier items or metadata items or preferences are compatible with the associated learning application's metadata items, the database 428 requests the generator 424 to generate and display a listing item price request interface with price request interface items and corresponding input areas to be chosen or filled in by the listing user for the listing item. If a price range item is relevant to the listing item or kind of listing user, the listing compatibility module 416 further requests the listing interface generator 426 to access the corresponding price range item for the listing item from price range database 420, generate a corresponding price range interface item, and display the same through the listing item price request interface on the listing user's user device 140.

At step 1112, the listing items database 430 stores the price data item received from the listing user and requests the listing compatibility module 416 to determine whether the listing price received from the listing user is within an optional price range stored for the kind of listing item in price range database 420 by the modular learning system 144. At step 1114, based on the numerical value entered in as a price for the listing item by the listing user for the price of the listing item in the currency preference, the listing compatibility module 416 accesses the price data item from the corresponding data field in listing items database 430, accesses the corresponding price range item from price range database 420, and determines whether the preferred listing price received by listing items database 430 is within the price range. If the price range item from price range database 420 is applicable and the price is not within the range, the compatibility module 416 requests listing interface generator 426 to generate a ‘price incompatible’ interface item with a corresponding input area to enter a new price and display the same to the listing user through a listing item price request interface on the user's user device 140.

At step 1116, in embodiments wherein the preferred price is within the applicable price range or in embodiments wherein no price range is applicable for the listing item, the marketplace interface generator 424 accesses the listing item with corresponding data items from listing items database 430, generates the corresponding microlearning listing interface items, optionally organizes the same in an listing item interface cell, and displays the same upon request to any of the plurality of compatible learning users in user database 202, through a microlearning marketplace interface generated by the marketplace interface generator 424 on each learning user 102's user device 140. If a consolidated microlearning service is requested to be assembled or purchased by a learning user 102 through the microlearning purchase management module 238 by adding compatible application services to a chosen learning application or set of learning applications, a consolidation item for the same may be generated by or chosen from the microlearning service consolidation module 422 and accessed by the marketplace interface generator 424 along with the individual listing items from listing items database 430. Marketplace interface generator 424 may generate a microlearning service consolidation interface with corresponding input areas for learning applications and compatible application services to be chosen by a given learning user 102, and may display the same with the corresponding listing interface items and input areas to the learning user 102 on the user 102's user device 140. Further, the corresponding purchase item compiled for the listing item in one of the applicable databases 402, 404, 406, 408, 410, 412 or 414 is accessed by the microlearning purchase management module 238 at the time of processing the purchase transaction for the purchase item purchased by any learning user 102.

In some embodiments, the method for purchasing a microlearning service through the microlearning purchase management module 238 may further include consolidating a plurality of application services with a learning application during the purchase of the learning application, in case the application services are required to be purchased to perform the learning applications through purchase management module 238. Although the method for managing a microlearning marketplace in a modular learning system environment is described as being composed of various steps, fewer or more steps (e.g., Determine Microlearning Service Consolidation Compatibility for Consolidation Item, Update Corresponding Purchase Items Database) may comprise the method with the present invention still falling within the scope of various embodiments.

### Computing Machine Architecture

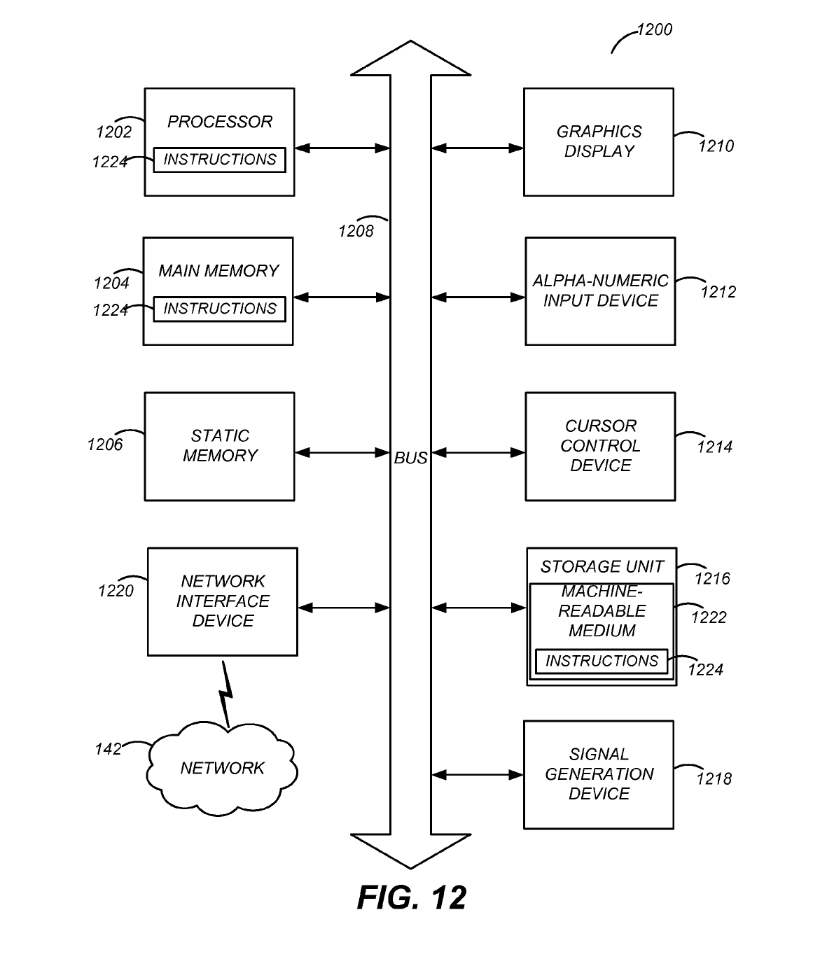

FIG. 12 is a block diagram illustrating components of an example machine 1200 suitable for use as a modular learning system 144 (e.g., as illustrated in FIGS. 1-4), in which any of the embodiments disclosed herein may be performed, according to one embodiment. This example machine is able to read instructions from a machine-readable medium and execute them in a processor (or controller).

Specifically, FIG. 12 shows a diagrammatic representation of a machine in the example form of a computer system 1200 within which instructions 1224 (e.g., software) for causing the machine to perform any one or more of the methodologies discussed herein may be executed. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 824 (sequential or otherwise) that specify actions to be taken by that machine. Further, while only a single machine is illustrated, the term “machine” shall also be taken to include any collection of machines that individually or jointly execute instructions 824 to perform any one or more of the methodologies discussed herein.

The example computer system 800 includes a processor 1202 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 1204, and a static memory 1206, which are configured to communicate with each other via a bus 1208. The computer system 1200 may further include a graphics display unit 1210 (e.g., a plasma display panel (PDP), a liquid crystal display (LCD), a projector, or a cathode ray tube (CRT)). The computer system 1200 may also include alphanumeric input device 1212 (e.g., a keyboard), a cursor control device 1214 (e.g., a mouse, a trackball, a joystick, a motion sensor, or other pointing instrument), a storage unit 1216, a signal generation device 1218 (e.g., a speaker), and a network interface device 1220, which also are configured to communicate via the bus 1208.

The storage unit 1216 includes a machine readable medium 1222 on which is stored instructions 1224 (e.g., software) embodying any one or more of the methodologies or functions described herein. The instructions 1224 (e.g., software) may also reside, completely or at least partially, within the main memory 1204 or within the processor 1202 (e.g., within a processor's cache memory) during execution thereof by the computer system 1200, the main memory 1204 and the processor 1202 also constituting machine-readable media. The instructions 1224 (e.g., software) may be transmitted or received over a network 142 via the network interface device 1220.

While machine readable medium 1222 is shown in an example embodiment to be a single medium, the term “machine-readable medium” should be taken to include a single medium or multiple media (e.g., a centralized or distributed database, or associated caches and servers) able to store instructions (e.g., instructions 1224). The term “machine-readable medium” shall also be taken to include any medium that is capable of storing instructions (e.g., instructions 1224) for execution by the machine and that cause the machine to perform any one or more of the methodologies disclosed herein. The term “machine-readable medium” includes, but not be limited to, data repositories in the form of solid-state memories, optical media, and magnetic media.

The modular learning system 144 may be one or more servers in which one or more methods disclosed herein are performed. The processor 1202 may be a microprocessor, a state machine, an application specific integrated circuit, a field programmable gate array, etc. (e.g., Intel® Pentium® processor). The main memory 1204 may be a dynamic random access memory and/or a primary memory of the modular learning system 144. The static memory 1206 may be a hard drive, a flash drive, and/or other memory information associated with the modular learning system 144.

The bus 1208 may be an interconnection between various circuits and/or structures of the modular learning system 144. The video display 1210 may provide graphical representation of information on the modular learning system 144. The alphanumeric input device 1212 may be a keypad, keyboard and/or any other input device. The cursor control device 1214 may be a pointing device such as a mouse.

The storage unit 1216 may be a hard drive, a storage system, and/or other longer term storage subsystem. The signal generation device 1218 may be a bios and/or a functional operating system of the modular learning system 144. The network interface device 1220 may be a device that may perform interface functions such as code conversion, protocol conversion and/or buffering required for communication to and from a network (e.g., the network 142 of FIG. 1). The machine readable medium 1222 may provide instructions 1224 on which any of the methods disclosed herein may be performed. The instructions 1224 may provide source code and/or data code to the processor 1202 to enable any one/or more operations disclosed herein. For example, the modular learning system 144 may be stored in the form of instructions 1224 on a storage medium such as the main memory 1204 and/or the machine readable medium 1222 such as compact disk.

In one embodiment, a non-transitory computer-readable storage medium having a program executable by a computing device (e.g., the modular learning system 144) causes the computing device to perform method steps illustrated in FIG. 11.

### Additional Configuration Considerations

As describing herein, the modular learning system provides a visual process for a learning user to create a microlearning stack to achieve an educational goal. The microlearning marketplace management module 242 enables a listing user to populate the learning application marketplace with information relating to learning tools, facilities, events, etc. associated with a learning application. As a result of the information contained in the learning application marketplace and the interfaces generated by the microlearning marketplace management module 242, the learning user may select a learning application and associated services to achieve an objective, such as achieving a particular swimming level. By proceeding through the interfaces illustrated in FIGS. 5-10, the learning user can select a learning application to achieve the objective, as well as an available facility and equipment required for completing the application. In one embodiment, information related to the performance of tutors, such as success rates of the tutors or success rates of learning users, who have performed applications under the tutors, may be retrieved from tutor database 208. Learning users may then view the tutor information through an interface (e.g., as illustrated in FIG. 6) to select a tutor for the chosen application.

A learning user may select a set of learning applications and associated services to achieve an objective, which are compiled and displayed to the learning user through a consolidated microlearning service interface (e.g., as illustrated in FIG. 10). In one embodiment, the microlearning marketplace management module 242 may determine the number and type of courses required to achieve a particular objective based on a selected tutor. For example, information about success rate of a selected tutor may indicate that students of the tutor master breaststroke after completing fewer applications than students of other tutors. If a learning user whose objective is to master breaststroke selects the successful tutor, the microlearning marketplace management module 242 may recommend that the learning user perform three learning applications, whereas if the same learning user were to select a different tutor, five learning applications may be recommended.

Throughout this specification, plural instances may implement modules, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate modules in example configurations may be implemented as a combined structure or module. Similarly, structures and functionality presented as a single module may be implemented as separate modules. These and other variations, modifications, additions, and improvements fall within the scope of the subject matter herein.

Certain embodiments are described herein as including functionality implemented in computing logic or a number of modules, components, or mechanisms, for example, as illustrated in FIGS. 2, 4, and 5. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by one or more processors, e.g., processor 1202, that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs)).

In another embodiment, the microlearning purchase and performance interface provided by the modular learning system 144 can be accessed over a local area network, intranet or virtual private network accessible to a limited plurality of user devices at a preschool, school, college, university, educational board, professional standards authority, coaching class, a company, HR department, training department or at a training organization through a user device.

In another embodiment, the microlearning purchase and performance interface provided by the modular learning system 144 can be accessed over a wide area network, General Packet Radio Service network, an Enhanced Data for Global Evolution network, a 3G telecommunications network, a 4G LTE telecommunications network or other telecommunications network through a user device.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Although the present embodiments have been described with reference to specific example embodiments, it will be evident that various modifications and changes may be made to these embodiments without departing from the broader spirit and scope of the various embodiments. For example, the various devices, modules, databases, etc. described herein may be enabled and operated using hardware circuitry (e.g., complementary metal-oxide-semiconductor (CMOS) based logic circuitry), firmware, software and/or any combination of hardware, firmware, and/or software (e.g., embodied in a machine readable medium).

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine modules that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

According to the embodiments described in FIG. 1 through 7, various methods and electric structures may be embodied using transistors, logic gates, and electrical circuits (e.g., Application Specific Integrated Circuitry and/or in Digital Signal Processor circuitry). For example, the purchase management module 238, performance management module 240 and other modules of FIGS. 1 to 4 may be enabled using a purchase management circuit, a performance management circuit, and other circuits using one or more of the technologies described herein. In addition, it will be appreciated that the various operations, processes, and methods disclosed herein may be embodied in a machine-readable medium and/or a machine accessible medium compatible with a data processing system (e.g., a server) and may be performed in any order. Accordingly, the specification and drawings are to be regarded in an illustrative rather than a restrictive sense.

Upon reading this disclosure, those of skill in the art will appreciate still additional alternative structural and functional designs for a system and a process for managing the purchase and performance of learning applications and associated application services in a microlearning stack through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

1-15. (canceled)

16. A computer-implemented method for providing a listing interface for listing items by listing users in an Internet-based learning application marketplace in a modular learning system and a marketplace interface that displays the listing items for use by learning users, the method comprising:
maintaining an Internet-based modular learning system including a plurality of processor-implemented modules, the processor-implemented modules including an electronic microlearning marketplace management module, an electronic microlearning performance management module, and an electronic microlearning purchase management module, the modular learning system operating in a modular learning environment and communicating with a plurality of kinds of users in the learning environment over an Internet-based computer network, the modular learning system managing modules of a learning experience in micro increments of time and money to enable the plurality of kinds of users to communicate with one another in the learning environment, wherein the kinds of users include listing users and learning users, the modules of the learning experience being associated with any two or more of a curriculum, a tangible learning facility, a standardized test, an electronic learning application, a tangible learning tool, a learning workshop, or a tutoring service, the Internet-based modular learning system being configured for:
enabling each of a plurality of learning users to manage a purchase of and, in a case where the learning experience includes completion of a learning performance, a performance of one or more of the modules of the learning experience for an electronic learning application;
enabling each of a plurality of listing users to list a plurality of listing items in the Internet-based learning application marketplace using an electronic listing interface, each listing item displayed on an electronic marketplace interface and associated with a tutoring service, a tangible tool or tool access, a learning facility access, a microlearning learning visit access, a microlearning workshop access, one of the plurality of learning applications, or a service usage;
maintaining an electronic learning application database including the plurality of learning applications, each of the plurality of learning applications being associated with metadata describing a price range, age level metadata that includes a minimum suggested age level or an age range of a learning user for the learning application, and performance type metadata indicating a performance type of the learning application, where the performance type includes a selected one of a theoria performance type or a praxis performance type;
the microlearning purchase management module automatically determining purchase compatibility and the microlearning performance management module determining performance compatibility with a selected one of the plurality of learning applications using at least the performance type metadata and the age level metadata through the learning application database;
receiving a listing request from the listing user specifying the learning application in the plurality of learning applications and a price;
the microlearning marketplace management module comparing the price with the price range associated with the learning application;
creating an electronic listing item associated with the learning application and adding the created electronic listing item to the plurality of listing items;
displaying the created electronic listing item associated with the learning application on the electronic marketplace interface;
receiving from one of the learning users a selection of one of the listing items associated with a corresponding one of the learning applications, the selected one of the listing items being a selected learning application and including tutor metadata, tools metadata, and learning facility metadata;
responsive to receiving the selection of the selected learning application, displaying to the one of the learning users via an electronic consolidated microlearning service interface an indication of the selected learning application and a plurality of application services associated with the selected learning application, the application services including one or more of a microlearning tutoring service compatible with the selected learning application based on the tutor metadata, a learning facility access to a tangible learning facility compatible with the selected learning application based on the learning facility metadata, and a learning tool access to a tangible learning tool compatible with the selected learning application based on the tools metadata;
responsive to the displaying the plurality of application services, receiving from the one of the learning users a selection of a microlearning tutoring service of the application services, and responsive thereto, adding the selected microlearning tutoring service to the electronic consolidated microlearning service;
responsive to the displaying the plurality of application services, receiving from the one of the learning users over the Internet-based computer network a second selection from among the plurality of application services of a learning facility access to a tangible learning facility or a learning tool access to a tangible learning tool, and responsive thereto, adding the second selection to the consolidated microlearning service;
generating, by a marketplace interface generator, the consolidated microlearning service interface including the selected one of the listing items, the selected microlearning tutoring service, and the second selection, and causing the consolidated microlearning service interface to be displayed through the electronic marketplace interface on a user device of the one of the learning users;
providing on the consolidated microlearning service interface a link to a personalized learning stream of the one of the learning users; and
adding the consolidated microlearning service to the personalized learning stream of the one of the learning users in response to a selection of the link.

17. The method of claim 16, further comprising:
maintaining a listing user database including the plurality of listing users, each listing user associated with a plurality of identity items;
determining a compatibility of the listing user with the learning application based on identity items associated with the listing user; and
creating a listing item associated with the learning application after authenticating the listing request based on the compatibility and adding the listing item associated with the learning application to the plurality of listing items.

18. The method of claim 17, wherein the identity items describe a language of the listing user and the compatibility is based on the similarity of the language of the listing user and the language of the learning application.

19. The method of claim 17, wherein the identity items describe a location of the listing user and the compatibility is based on the similarity of the location of the listing user and the location of the learning application.

20. The method of claim 16, wherein displaying the created listing item on the marketplace interface comprises displaying a link to a learning application purchase interface.

21. A modular learning system for providing a listing interface for listing items by listing users in an Internet-based learning application marketplace in a modular learning system and a marketplace interface that displays listing items for use by listing users, the system comprising:
one or more processors configured to execute instructions stored on one or more computer-readable storage media;
a non-volatile memory comprises:
instructions for execution on the one or more processors, to perform steps comprising: maintaining an Internet-based modular learning system including a plurality of processor-implemented modules, the processor-implemented modules including an electronic microlearning marketplace management module, an electronic microlearning performance management module, and an electronic microlearning purchase management module, the modular learning system operating in a modular learning environment and communicating with a plurality of kinds of users in the learning environment over an Internet-based computer network, the modular learning system managing modules of a learning experience in micro increments of time and money to enable the plurality of kinds of users to communicate with one another in the learning environment, wherein the kinds of users include listing users and learning users, the modules of the learning experience being associated with any two or more of a curriculum, a tangible learning facility, a standardized test, an electronic learning application, a tangible learning tool, a learning workshop, or a tutoring service, the Internet-based modular learning system being configured for configured for:
enabling each of a plurality of learning users to manage a purchase of and, in a case where the learning experience includes completion of a learning performance, a performance of one or more of the modules of the learning experience for an electronic learning application;
enabling each of a plurality of listing users to list a plurality of listing items in the Internet-based learning application marketplace using an electronic listing interface, each listing item displayed on an electronic marketplace interface and associated with a tutoring service, a tangible tool or tool access, a learning facility access, a microlearning learning visit access, a microlearning workshop access, one of the plurality of learning applications, or a service usage;
maintaining an electronic learning application database including the plurality of learning applications, each of the plurality of learning applications being associated with metadata describing a price range, age level metadata that includes a minimum suggested age level or an age range of a learning user for the learning application, and performance type metadata indicating a performance type of the learning application, where the performance type includes a selected one of a theoria performance type or a praxis performance type;
the microlearning purchase management module automatically determining purchase compatibility and the microlearning performance management module determining performance compatibility with a selected one of the plurality of learning applications using at least the performance type metadata and the age level metadata through the learning application database;
receiving a listing request specifying the learning application in the plurality of learning applications and a price;
the microlearning marketplace management module comparing the price with the price range associated with the learning application creating a listing item associated with the learning application;
creating an electronic listing item associated with the learning application and adding the created electronic listing item to the plurality of listing items;
displaying the created electronic listing item associated with the learning application on the electronic marketplace interface;
receiving from one of the learning users a selection of one of the listing items associated with a corresponding one of the learning applications, the selected one of the listing items being a selected learning application and including tutor metadata, tools metadata, and learning facility metadata;
responsive to receiving the selection of the selected learning application, displaying to the one of the learning users via an electronic consolidated microlearning service interface an indication of the selected learning application and a plurality of application services associated with the selected learning application, the application services including one or more of a microlearning tutoring service compatible with the selected learning application based on the tutor metadata, a learning facility access to a tangible learning facility compatible with the selected learning application based on the learning facility metadata, and a learning tool access to a tangible learning tool compatible with the selected learning application based on the tools metadata;
responsive to the displaying the plurality of application services, receiving from the one of the learning users a selection of a microlearning tutoring service of the application services, and responsive thereto, adding the selected microlearning tutoring service to the electronic consolidated microlearning service;
responsive to the displaying the plurality of application services, receiving from the one of the learning users over the Internet-based computer network a second selection from among the plurality of application services of a learning facility access to a tangible learning facility or a learning tool access to a tangible learning tool, and responsive thereto, adding the second selection to the consolidated microlearning service;
generating, by a marketplace interface generator, the consolidated microlearning service interface including the selected one of the listing items, the selected microlearning tutoring service, and the second selection, and causing the consolidated microlearning service interface to be displayed through the electronic marketplace interface on a user device of the one of the learning users;
providing on the consolidated microlearning service interface a link to a personalized learning stream of the one of the learning users; and
adding the consolidated microlearning service to the personalized learning stream of the one of the learning users in response to a selection of the link.

22. The system of claim 21, wherein the microlearning marketplace management module is further configured for:
maintaining a listing user database including the plurality of listing users, each listing user associated with a plurality of identity items;
determining a compatibility of the listing user with the learning application based on identity items associated with the listing user; and
creating a listing item associated with the learning application after authenticating the listing request based on the compatibility and adding the listing item associated with the learning application to the plurality of listing items.

23. The system of claim 22, wherein the identity items describe a language of the listing user and the compatibility is based on the similarity of the language of the listing user and the language of the learning application.

24. The system of claim 22, wherein the identity items describe a location of the listing user and the compatibility is based on the similarity of the location of the listing user and the location of the learning application.

25. The system of claim 21, wherein displaying the created listing item on the marketplace interface comprises displaying a link to a learning application purchase interface.

26. One or more non-transitory computer-readable storage media storing computer program instructions executable by a processor for performing a method for providing a listing interface for listing items by listing users in an Internet-based learning application marketplace in a modular learning system and a marketplace interface that displays listing items for use by listing users, the method comprising:
maintaining an Internet-based modular learning system including a plurality of processor-implemented modules, the processor-implemented modules including an electronic microlearning marketplace management module, an electronic microlearning performance management module, and an electronic microlearning purchase management module, the modular learning system operating in a modular learning environment and communicating with a plurality of kinds of users in the learning environment over an Internet-based computer network, the modular learning system managing modules of a learning experience in micro increments of time and money to enable the plurality of kinds of users to communicate with one another in the learning environment, wherein the kinds of users include listing users and learning users, the modules of the learning experience being associated with any two or more of a curriculum, a tangible learning facility, a standardized test, an electronic learning application, a tangible learning tool, a learning workshop, or a tutoring service;
enabling each of a plurality of learning users to manage a purchase of and, in a case where the learning experience includes completion of a learning performance, a performance of one or more of the modules of the learning experience for an electronic learning application;
enabling each of a plurality of listing users to list a plurality of listing items in the Internet-based learning application marketplace using an electronic listing interface, each listing item displayed on an electronic marketplace interface and associated with a tutoring service, a tangible tool or tool access, a learning facility access, a microlearning learning visit access, a microlearning workshop access, one of the plurality of learning applications, or a service usage;
maintaining an electronic learning application database including the plurality of learning applications, each of the plurality of learning applications being associated with metadata describing a price range, age level metadata that includes a minimum suggested age level or an age range of a learning user for the learning application, and performance type metadata indicating a performance type of the learning application, where the performance type includes a selected one of a theoria performance type or a praxis performance type;
the microlearning purchase management module automatically determining purchase compatibility and the microlearning performance management module determining performance compatibility with a selected one of the plurality of learning applications using at least the performance type metadata and the age level metadata through the learning application database;
receiving a listing request specifying the learning application in the plurality of learning applications and a price;
the microlearning marketplace management module comparing the price with the price range associated with the learning application;
creating an electronic listing item associated with the learning application and adding the created electronic listing item to the plurality of listing items;
displaying the created electronic listing item associated with the learning application on the electronic marketplace interface;
receiving from one of the learning users a selection of one of the listing items associated with a corresponding one of the learning applications, the selected one of the listing items being a selected learning application and including tutor metadata, tools metadata, and learning facility metadata;
responsive to receiving the selection of the selected learning application, displaying to the one of the learning users via an electronic consolidated microlearning service interface an indication of the selected learning application and a plurality of application services associated with the selected learning application, the application services including one or more of a microlearning tutoring service compatible with the selected learning application based on the tutor metadata, a learning facility access to a tangible learning facility compatible with the selected learning application based on the learning facility metadata, and a learning tool access to a tangible learning tool compatible with the selected learning application based on the tools metadata;
responsive to the displaying the plurality of application services, receiving from the one of the learning users a selection of a microlearning tutoring service of the application services, and responsive thereto, adding the selected microlearning tutoring service to the electronic consolidated microlearning service;
responsive to the displaying the plurality of application services, receiving from the one of the learning users over the Internet-based computer network a second selection from among the plurality of application services of a learning facility access to a tangible learning facility or a learning tool access to a tangible learning tool, and responsive thereto, adding the second selection to the consolidated microlearning service;
generating, by a marketplace interface generator, the consolidated microlearning service interface including the selected one of the listing items, the selected microlearning tutoring service, and the second selection, and causing the consolidated microlearning service interface to be displayed through the electronic marketplace interface on a user device of the one of the learning users;
providing on the consolidated microlearning service interface a link to a personalized learning stream of the one of the learning users; and
adding the consolidated microlearning service to the personalized learning stream of the one of the learning users in response to a selection of the link.

27. The one or more non-transitory computer-readable storage media of claim 26, wherein the method further comprises:
maintaining a listing user database including the plurality of listing users, each listing user associated with a plurality of identity items;
determining a compatibility of the listing user with the learning application based on identity items associated with the listing user; and
creating a listing item associated with the learning application after authenticating the listing request based on the compatibility and adding the listing item associated with the learning application to the plurality of listing items.

28. The one or more non-transitory computer-readable storage media of claim 27, wherein the identity items describe a language of the listing user and the compatibility is based on the similarity of the language of the listing user and the language of the learning application.

29. The one or more non-transitory computer-readable storage media of claim 27, wherein the identity items describe a location of the listing user and the compatibility is based on the similarity of the location of the listing user and the location of the learning application.

30. The one or more non-transitory computer-readable storage media of claim 26, wherein displaying the created listing item on the marketplace interface comprises displaying a link to a learning application purchase interface.
